(19) United States
(12) Patent Application Publication
(10) Pub. No.: US 2013/0346170 A1
(43) Pub. Date: Dec. 26, 2013

(54) Customized Customer Loyalty Rewards Program Enhanced Rewards Distribution System and Method

(71) Applicants: Jacob H. Epstein, Medford, MA (US); Mark A. Fabrizio, Lowell, MA (US); Andrew J. Stone, Somerville, MA (US); William C. Cray, East Palo Alto, CA (US)

(72) Inventors: Jacob H. Epstein, Medford, MA (US); Mark A. Fabrizio, Lowell, MA (US); Andrew J. Stone, Somerville, MA (US); William C. Cray, East Palo Alto, CA (US)

(73) Assignee: BOZUKO, INC., Medford, MA (US)

(21) Appl. No.: 13/977,287

(22) PCT Filed: Jan. 10, 2012
(86) PCT No.: PCT/US2012/020753

§ 371 Date: Sep. 5, 2013

Related U.S. Application Data
(60) Provisional application No. 61/431,265, filed on Jan. 10, 2011.
(60) Provisional application No. 61/480,095, filed on Apr. 28, 2011.

(51) Int. Cl. G06Q 30/02

(52) U.S. Cl. CPC G06Q 30/0226; G06Q 30/0212
USPC 705/14.14

(57) ABSTRACT

A customer loyalty rewards program random enhanced reward distribution system and method may comprise a server (304) receiving an indication that a user is a qualified participant because the user is one of a recipient of customer loyalty rewards program currency and qualified to be such a recipient. The server (304) may be configured to provide the user with a representation of a game (1400), via a communication network (290). The server (304) may be configured to receive, via the communication network (290), from the user, an indication that the user participates (1402) using the representation of the game (1400). The server (304) may determine whether the user is an enhanced reward recipient. The server (304) may be configured to determine whether the user is an enhanced reward recipient by selecting a position in a results array (100) predetermined to contain the indication (104) of whether the user is an enhanced reward recipient.

### RELATED CASES

The present application claims priority to an earlier filed U.S. Provisional Patent Application No. 61/431265, filed on Jan. 10, 2010, entitled METHOD OF OFFERING A CUSTOM GAME OF CHANCE FOR CUSTOMER REWARDS PROGRAMS, and U.S. Provisional Patent Application No. 61/480095, filed on Apr. 28, 2011, entitled CUSTOMIZED CUSTOMER LOYALTY REWARDS PROGRAM RANDOM ENHANCED REWARDS DISTRIBUTION SYSTEM AND METHOD, the disclosures of each of which are incorporated here by reference fully and completely as is duplicated in the present application, and for all purposes whatsoever.

### BACKGROUND

A customer loyalty rewards program randomly selected enhanced rewards distribution system stimulates user participation and thus, advertising value to the merchant using the system and method.

### SUMMARY

A system and method to provide customer loyalty program and other participants randomly selected rewards through the presentation of representations of games of chance to which the user/participant responds with a simulated play of the game and the system randomly determined if the participation event results in the participant/user being awarded a reward of a predetermined value.

A customer loyalty rewards program random enhanced reward distribution system and method may comprise a random enhanced reward distribution system server receiving an indication that a user is a qualified participant because the user is one of a recipient of customer loyalty rewards program currency and qualified to be a recipient of customer loyalty rewards program currency. The random enhanced reward distribution server configured to provide the user with a representation of a game, via a communication network. The random enhanced reward distribution system server (304) may be configured to receive, via the communication network, from the user, an indication that the user participates using the representation of the game. The random enhanced reward distribution server may determine whether the user is an enhanced reward recipient. The reward distribution server may be configured to determine whether the user is an enhanced reward recipient by selecting a position in a results array predetermined to contain the indication of whether the user is an enhanced reward recipient.

The system and method may comprise the server configured to receive, via a communication network, from a merchant, a definition of a customer loyalty reward program random enhanced reward distribution campaign, the random enhanced reward distribution system server configured to conduct the random enhanced reward distribution system campaign defined by the merchant. The definition by the merchant may a cost to the merchant criteria and the server may be configured to create the results array for the campaign wherein a number of participants receiving the random enhanced reward within a given number of participation events satisfies the cost to the merchant criteria.

The random enhanced reward distribution system server configured to provide a reward distribution system campaign definition interface whereby a merchant having a consumer loyalty program can define the random enhanced reward distribution campaign and administer the random enhanced reward distribution system defined by the merchant for the merchant. The merchant may define at least one aspect of the enhanced reward distribution campaign. The customer loyalty reward program may be a location check-in reward program and the customer loyalty program currency may be a check-in reward. The customer loyalty reward program may be a behavior inducement check-in. The enhanced customer loyalty program reward may be higher than the check-in reward. The enhanced customer loyalty program reward may be higher than an amount of customer loyalty currency normally received to induce the behavior. The enhanced reward distribution system server may be configured to provide to the merchant a loyalty program enhanced reward campaign matrix populated by a selection of predetermined campaigns of increasing cost to the merchant progressing down and/or to the right in the matrix and the server may be configured to receive from the merchant a selection of at least one enhanced reward campaign from the enhanced reward campaign matrix for the reward distribution system server to conduct.

A system and method is disclosed which may comprise providing, via a random enhanced reward distribution server, a representation of a game of chance to a participating user with an opportunity to engage in a participation event; determining, via the random enhanced reward distribution server, the outcome of the participation event; providing, via the random enhanced reward distribution server, to the participant a representation of an outcome of the participant event in the form of an outcome of the game of chance resulting in one of a distribution of an enhanced reward and a non-distribution of an enhanced reward; notifying, at least in part via the random enhanced reward distribution server, at least one of a plurality of social network connections of the participant of the outcome of the participation event.

The method and apparatus may comprise receiving, via a random enhanced reward distribution system server, an indication that a user is a qualified participant because the participant is a participant in a non-location check-in event wherein the participant engages in an activity in which a merchant desires the participant to engage; providing, via the random enhanced reward distribution server, the participant with a representation of a game; receiving, via the random enhanced reward distribution system server, from the participant, an indication that the participant engages in a participation event using the representation of the game; and determining, via the random enhanced reward distribution server, whether the participation event results in the participant receiving an enhanced reward. The system and method may also comprise providing to a merchant having a customer loyalty program random enhanced reward distribution system account, via a random enhanced reward distribution system server, an enhanced reward distribution campaign matrix, each campaign in the campaign matrix defining a game of chance provided to a participant in the campaign, having an increasing level of merchant reward value commitment along a first coordinate axis of the matrix and an increased level of participant advertising value to the merchant along a second coordinate axis of the matrix; and administering at least one customer loyalty program enhanced reward distribution campaign, via the random enhanced reward distribution system server, selected from the matrix by the merchant, on behalf of the merchant.

A method and apparatus may comprise receiving, via a random enhanced reward distribution system server, an indication that a participant is a qualified participant as defined by a merchant loyalty program enhanced reward distribution campaign, the campaign defining a temporal duration D for the campaign, and defining a respective defined award play time tₐ at which each respective enhanced reward will be awarded to a participant during the duration D of the campaign; providing, via the random enhanced reward distribution server, the participant with a representation of a game; receiving, via the random enhanced reward distribution system server, from the participant, an indication that the participant engages in a participation event using the representation of the game at a participation play time tₚ; and determining, via the random enhanced reward distribution server, whether the participation event results in the participant being awarded an enhanced reward based on one of the participation play time tₚ corresponding to a defined award play time tₐ and the existence of at least one unawarded enhanced reward for which a previous defined award play time tₐ, within the duration D of the campaign, which defined award play time tₐ passed without a participation event at a participation play time tₚ corresponding to the defined award play time tₐ that passed.

### BRIEF DESCRIPTION OF THE DRAWING

FIG. 1 discloses an example of a results array according to aspects of embodiments of the disclosed subject matter;

FIG. 2 discloses an example of a results array according to aspects of embodiments of the disclosed subject matter;

FIGS. 3a-3d disclose examples of user interface displays according to aspects of embodiments of the disclosed subject matter;

FIGS. 4a-4c disclose examples of user interface displays according to aspects of embodiments of the disclosed subject matter;

FIG. 5 shows an example of a winner's list display according to aspects of embodiments of the disclosed subject matter;

FIG. 6 shows an example of a customer loyalty rewards program random enhanced rewards distribution system campaign matrix according to aspects of embodiments of the disclosed subject matter;

FIG. 7 shows an example of a system according to aspects of embodiments of the disclosed subject matter;

FIG. 8 show an example of a process flow according to aspects of embodiments of the disclosed subject matter;

FIG. 9 show an example of a process flow according to aspects of embodiments of the disclosed subject matter;

FIG. 10 show an example of a process flow according to aspects of embodiments of the disclosed subject matter;

FIG. 11 shows an example of a rewards definition process user interface display according to aspects of the disclosed subject matter;

FIG. 12 shows an example of a user/participant campaign selection notification user interface display according to aspects of the disclosed subject matter;

FIG. 13 shows an example of a campaign rewards definition user interface display according to aspects of the disclosed subject matter;

FIGS. 14a-c show examples of a customer loyalty rewards program random enhanced reward distribution system user interface displays according to aspects of the disclosed subject matter;

FIG. 15 shows an example of a customer loyalty rewards program random enhanced reward distribution system user social network interface display according to aspects of the disclosed subject matter;

FIG. 16 shows an example of a customer loyalty rewards program random enhanced reward distribution system user social network interface display according to aspects of the disclosed subject matter;

FIGS. 17a-17b show examples of a customer loyalty rewards program random enhanced reward distribution system game representation user interface according to aspects of the disclosed subject matter;

FIGS. 18a-18d shows further examples of user interface displays according to aspects of embodiments of the disclosed subject matter similar to FIGS. 4a-4d;

FIG. 19 shows an example of a campaign results report user interface display according to aspects of embodiments of the disclosed subject matter;

FIG. 20 shows an example of a graphical representation of a campaign results report according to aspects of embodiments of the disclosed subject matter;

FIG. 21 shows an example of a graphical representation of a campaign results report according to aspects of embodiments of the disclosed subject matter;

FIGS. 22a-j show charts illustrating aspects of a temporally bounded customer loyalty rewards program random enhanced reward distribution system game presentation according to aspects of embodiments of the disclosed subject matter;

FIG. 23 shows an example of a database organization according to aspects of embodiments of the disclosed subject matter;

FIG. 24 shows an example of a database organization according to aspects of embodiments of the disclosed subject matter;

FIG. 25 shows an example of a database organization according to aspects of embodiments of the disclosed subject matter;

### DETAILED DESCRIPTION

A method is described to allow a merchant offering for sale goods or services or other entity to increase the effectiveness of a customer loyalty rewards program and also increase customer traffic in a merchant location(s) and sales, e.g., by randomly distributing loyalty program rewards of a higher value (an “enhanced reward”) to a selected few randomly chosen loyalty program reward qualifiers. This can be done, e.g., through the provision to the loyalty program reward qualifiers of a representation of a game of chance or access to the representation of the game of chance with the entitlement to an actual loyalty reward. The receipt of the enhanced reward is determined by a randomly selected representation of the outcome of the represented game of chance displayed to the customer/user. The loyalty reward program could be a check-in program using one of a number of social networks, such as Facebook, Foursquare, Twitter, Gowalla, Loopt, BrightKite, Whrrl and LinkedIn, and other forms of Internet based group communications like Groupon (for attracting new customers) chat rooms, blogs and the like. The presentation of the representation of the game of chance or access to the presentation of the representation of the game of chance may be through an agent of the merchant, such as a loyalty program enhanced reward random reward distribution system (“RDS”) service, which may control a loyalty program random reward distribution system server.

The disclosed subject matter is an application which allows a merchant or other business entity, e.g., a location where businesses congregate, e. g., a mall, an airport, a stadium, etc. to create a customized loyalty program RDS for enhanced rewards through, e.g., an RDS server for the loyalty program, such as a check-in program. Customers/users can interact, e.g., over a mobile user device, e.g., with the RDS, while actually at the merchant location. It will be understood that the types of business entity where other merchant locations are congregated may have a relationship with the RDS in and of itself, such that a check-in at any individual such business location, such as in a co-located merchant store, the food court, main passageways, parking garage and the like, may be a check-in for a customer loyalty program of the mall, stadium, arena, airport, park, etc. independently of any individual merchant at the location participating in the check-in RDS. Alternatively, the multiple-merchant business entity may be in the RDS in partnership with one or more merchants at the multiple-merchant location, such that, e.g., the mall, or the like entity, subsidizes the enhanced rewards for each separately participating merchant at the multiple-merchant location, or the check-in at the co-located merchant may constitute a check-in for purposes of the mall loyalty rewards program and also, when occurring at a specific merchant location in the multi-merchant location which is also participating with the RDS, then as a separate check-in also at that particular merchant for purposes of the check-in loyalty program enhanced rewards distribution system of that particular merchant. As another possibility, in lieu of, or complementing either or both of the just mentioned possibilities, the business entity running the multiple-merchant location mall, etc., may provide a much larger enhanced reward, e.g., an automobile awarded to a check-in participant in an RDS associated with the mall or an individual store, e.g., at much lower frequency of award, monthly, tri-monthly, semi-annually, etc.

The merchant may configure all of the criteria for loyalty program enhanced reward distribution system participation (a campaign), such as checking-in to an online social network and other possible requirements. The merchant may also indentify the type and number of enhanced rewards to be awarded, such as merchandise or services. Many other parameters pertaining to the loyalty program enhanced reward distribution system may be set by the merchant(s), e.g., as outlined below. A merchant account administrator can create a “reward distribution account” on-line, e.g., at the RDS server. This can be done using an on-line tool, called the “core application,” running, e.g., on the RDS server operated by the loyalty program random enhanced reward distribution system operator. The core application can be used to control all user game selections, participation and random selection of enhanced reward recipients, etc. A merchant account administrator may configure a loyalty program enhanced reward distribution account on the RDS server, pursuant to whatever contractual arrangements may be needed between the merchant and the loyalty program RDS operator, then optionally associate the RDS account with a location or locations of the merchant. Each account may involve a single location or multiple locations, each location may involve a single campaign or multiple campaigns as defined in more detail below. It will be understood that the contractual relationship or parts of the contractual relationship may be established on-line before or as part of any merchant loyalty program random enhanced reward distribution account/campaign(s) being created. The association with a physical merchant location can be necessary to later enforce that a check-in normal reward recipient or qualifier is located at the physical location of the merchant, and thus properly checked-in, where applicable.

A merchant account administrator may associate a loyalty program random enhanced reward distribution campaign of the merchant with one or more online social network accounts. This can allow the RDS to associate with the social network(s) and, e.g., utilize any tools which the social network(s) provides. Aspects of the merchant and its business may be automatically imported from the social network account of the merchant to the loyalty program random enhanced rewards distribution system account of the merchant including physical location and contact information. This may, e.g., be already stored by the social network as, e.g., a “check-in location,” e.g., on a “check-in location” or “merchant location” page within the on-line presence of the social network. For example in the case of Facebook, the merchant may require that users check-in to their Facebook Place page or “like” them on Facebook, or both, as discussed more below, in order to be eligible to seek the enhanced check-in reward. If a merchant account administrator logs on to the RDS campaign account of the merchant and grants the proper permissions by applying the core application, the core application may push and pull the necessary information to and from the Facebook business location page. Alternatively, the merchant may continue to operate under whatever check-in reward system is in place, e.g., with the social network, in conjunction with what the particular social networking system is providing the merchant and the users, e.g., notification of friends of the check-in and/or the check-in at a merchant that the user has indicated the user “likes.” The social network may continue to provide, either directly or through the RDS server, the opportunity for a check-in reward recipient to directly engage in a participation event with a representation of the game of chance in an attempt to be selected as the recipient of an enhanced check-in reward or allow the check-in reward recipient to convert the usual check-in reward token/coupon for such an opportunity.

A merchant account administrator may also elect to associate the RDS account of the merchant with a geographical location or locations. This can allow the RDS server to associate with that location or locations and may be used to require that the attempt to be the randomly selected distributee of an enhanced check-in reward be undertaken at or near that specific location or locations or within some selected time period after the check-in at or near that specific location or locations took place. A merchant account administrator can structure a “campaign”, using the merchant RDS account, which can encompass all of the elements related to both the user and merchant RDS involvement, as discussed in more detail below with respect to the loyalty program enhanced reward distribution system matrix, which may actually involve a plurality of campaigns of varying merchant commitment and varying user/participant levels of advertising value to the merchant, as discussed in more detail below. This structuring can call for the administrator to program some or all of the following variables into the core application via the merchant loyalty rewards program enhanced reward distribution campaign account. As will be understood by those skilled in the art, such may be accomplished by the merchant account administrator through interaction, such as prompted interaction, with a graphical user interface provided by the RDS, e.g., with pop-up displays and selection click-on buttons, and explanatory text and graphics as needed.

Representation of the Game type (vg)—A merchant account administrator can select the type of game or games to be utilized in a given loyalty reward program enhanced reward distribution campaign, such as a check-in loyalty program enhanced rewards distribution campaign. The core application may have a wide selection of representations of game types to choose from such as a slot machine, scratch tickets, dice, poker and other standard chance-based game formats. Representations of games of chance of all types, conventional and unconventional, may be made available. Representations of games based on approximate odds, such as sporting game outcomes, real lottery tickets, electronic versions of actual Casino betting games of chance, and the like may be available.

Means of entry (me)—A merchant account administrator may define the requirements that a user must satisfy before participating in the campaign, which may also vary with the level of merchant commitment selected for a particular campaign, as explained in more detail below. To satisfy the means of entry to participate in the particular campaign a user may have to, at a minimum, satisfy one or more of the following:

Be at a specific merchant location per the defined merchant location or locations with a mobile user device. The user may further be required to have visited some subset of a set of merchant locations before satisfying the means of entry requirement, e.g., the user may be required to have previously checked-in a plurality of times at one or more merchant location(s) to qualify. This location requirement on the user may be enforced by one or more of the following methods: GPS or other location based technology; a specific, defined and detectable radio signal such as a wifi or Bluetooth network; use of the camera on a mobile device to scan a code or take an identifiable picture; entering a specific access code which was communicated to the user by some means at the location; communication with another device which is at the location using any of the features available on the phone such as speaker, accelerometer or infrared; “check in” to the merchant location using a defined social network and mobile device, as an alternative to or in addition to the location verification requirements noted above; “like” the merchant using a defined social network procedure for registering; confirm that the user is a certain age in order to participate, which also may come from profile information with the social network or with the merchant or with the RDS server; enter a valid code communicated to the user by some means (examples of this communication can include television or radio receipt, newspaper, web-page, billboard, word of mouth, etc.); scan a bar code using the mobile user device; take a picture of a specific image or in a specific place using the mobile user device; record a specific audio signal using the mobile user device; recommend to friends via some digital means (email, text message, social network, etc) that they perform some action (download an application, come to a location, social network action, submit profile information, agree to receipt of advertisements/coupons, etc.), which may be done automatically by the social network or the RDS or both together as part of the check-in process; satisfy some other means of entry R times. In this case, a user may be required to be at one location or one of several locations R number of times before they have satisfied the means of entry; be one of S number of people who have performed some other means of entry (such as be at a location), where S is defined by the merchant administrator. In this case, if S number of people perform some action, all S users may be considered to have satisfied the means of entry.

Participation frequency F[me]—defines how often a user is eligible to satisfy the means of entry and participate. A merchant may want to restrict users to a maximum participation frequency, such as once per day, once or more per week, or several times the weekly rate per month, or the like. Participation frequency may be on a per-means-of-entry basis, meaning a user may be able to satisfy different means of entry at the same or different frequencies, such as, being on a per-campaign basis. Length of Campaign (T)—this can define the time period where a check-in or other loyalty program reward distribution system campaign will be made available to users. Length can be specified as a fixed time period or a specific start and end point in time, or other ways, such as total cost of the campaign, number of times a representation of the game is to be presented, number of prizes given, etc. Enhanced rewards (P)—The merchant account administrator may specify the available enhanced reward information for a given campaign. For each enhanced reward type [p], the merchant account administrator may specify the following enhanced reward information. Enhanced reward title (Pt[p])—a short name of the available enhanced reward which will be conveyed to the user, e.g., a Boston Patriots NFL T-shirt, team jersey, football, etc.

Available quantity (Pq[p])—the quantity of this enhanced reward which is available over the course of the entire campaign, or the total cost of the enhanced reward(s), e.g., in a campaign where more than one enhanced reward is offered, e.g., with a separate, though not necessarily different, probability of each user being selected as a randomly selected distributee for each different reward. Enhanced reward Details (Pd[p])—more detailed enhanced reward information, e.g., model number, manufacturer, wholesale cost, retail price, terms of use, etc. for the user. Enhanced reward expiration time (Pe[p])—the amount of time the user has to redeem the enhanced reward before it expires and is no longer redeemable. Enhanced reward redemption method (Pr[p])—the mechanisms available to the user to redeem this enhanced reward type. Pr[p] may be in-person, email, shipped, displayed bar-code, etc., and may involve the merchant, the RDS server operator or an agent of either or both. Enhanced reward cost to the merchant (Pc[p])—the cost per enhanced reward and/or campaign to the merchant. Enhanced reward value (Pv[p])—the retail price or other measure of value of this enhanced reward type if sold to a consumer in the public.

For every single enhanced reward available the core application can then create a universally unique enhanced reward identifier (P[i]) for that specific enhanced reward and the associated campaign. The number of unique identifiers created will be equal to the sum of Pq[p] for all p. Each identifier (P[i]) may be then used to reference the details about that enhanced reward including Pt[p], Pd[p] and other enhanced reward specific data and to manage redemption of the enhanced reward and manage the overall campaign. A globally unique identifier (“GUID,” as is well known in the art (see, http://en.wikipedia.org/wiki/Globally_unique_identifier) or other extremely secure randomly generated number or code may be utilized.

The merchant account administrator may optionally upload or enter their own set of unique prize identifiers (P[ib]) which may be stored along with the core application unique identifier, P[i]. This merchant unique identifier, P[ib], may then be used by the merchant or merchant computerized tracking system, alone or in combination with the RDS unique identifier, to internally register and monitor and verify unique enhanced reward activity, e.g., such as redemption. The P[ib] may be displayed in some readable form or could be used to generate a bar code or the like encoded identifier, as are well known in the art, which can, e.g., be scanned by a merchant computerized tracking system. Total cost of the campaign (C)—This is the total cost to the merchant if all available enhanced rewards for the given campaign are redeemed. If the merchant account administrator has specified the quantity available of each enhanced reward (Pq[p]) and the cost to the business of each enhanced reward (Pc[p]), C may be calculated as the product of Pq[p]*Pc[p] for all enhanced rewards (p) for the given campaign. Total number of participation events (N)—This is the number of total times a participant may seek to be a random distributee of an enhanced reward during the campaign. A participation, i.e., participation event, is defined by an atomic action by a user which may result in being a randomly selected recipient of a loyalty program, e.g., check-in program, campaign enhanced reward, and may directly or indirectly account for such things as free plays awarded by the RDS. Odds of being randomly selected to receive a enhanced reward p (O[p])—The odds of any given attempt at being randomly selected as the recipient of a loyalty program enhanced reward (a participation event) resulting in being awarded the enhanced reward for each enhanced reward type (p) for a single participation. This, again, may directly or indirectly account for replays awarded, or replays may be considered a separate element of the campaign and not directly factored into the odds (O[p]). Each set of odds O[p] may be represented as A:B where for every B plays users are awarded a quantity A of enhanced reward p, once again, accounting for awarded replays or not. As an example, participants at higher levels of advertising value to the merchant, as discussed below in regard to the rewards distribution matrix, may get free plays at some probability during a given participation event, so that the enhanced reward is still granted A times for each B events, but for some participants a plurality of participation events, on average, will only count as one of the B events in the results array due to being awarded a free play or plays. It will be understood that other ways of carrying out free plays may also be applied.

Total number of entries into the campaign (E)—Users may enter the contest one or more times per the requirements of participation. Entry into the campaign results in one or more participation events. Number of plays per means of entry (n[me])—Users may enter the campaign and acquire some number of available participation events (n) by satisfying the requirements of one or more means of entry (me). There may be a single or multiple means of entry requirement for a campaign available to any given user. The number of participation events awarded to a user for any given means of entry may be fixed or variable based on the means of entry. Fixed—All entries into the campaign result in equal number of participation events available to the user who has entered, i.e., no free plays. In this case n[me]=p for all means of entry (me) where (p) is some fixed number of plays greater than or equal to 1. Variable—each entry to the campaign may result in a different number of plays available to the user who has entered based on the user's means of entry. In this case n[me1]=p1, n[me2]=p2, n[me3]=p3 . . . where an entry into the campaign using means of entry me1 results in p1 number of participation events, etc. This may also be affected by having some results of participation be the receiving of a free participation, a draw in the particular participation, no winner and no loser, which can, depending on the frequency of the grant of a free participation, change the effective number of participation events available to the user(s) on average.

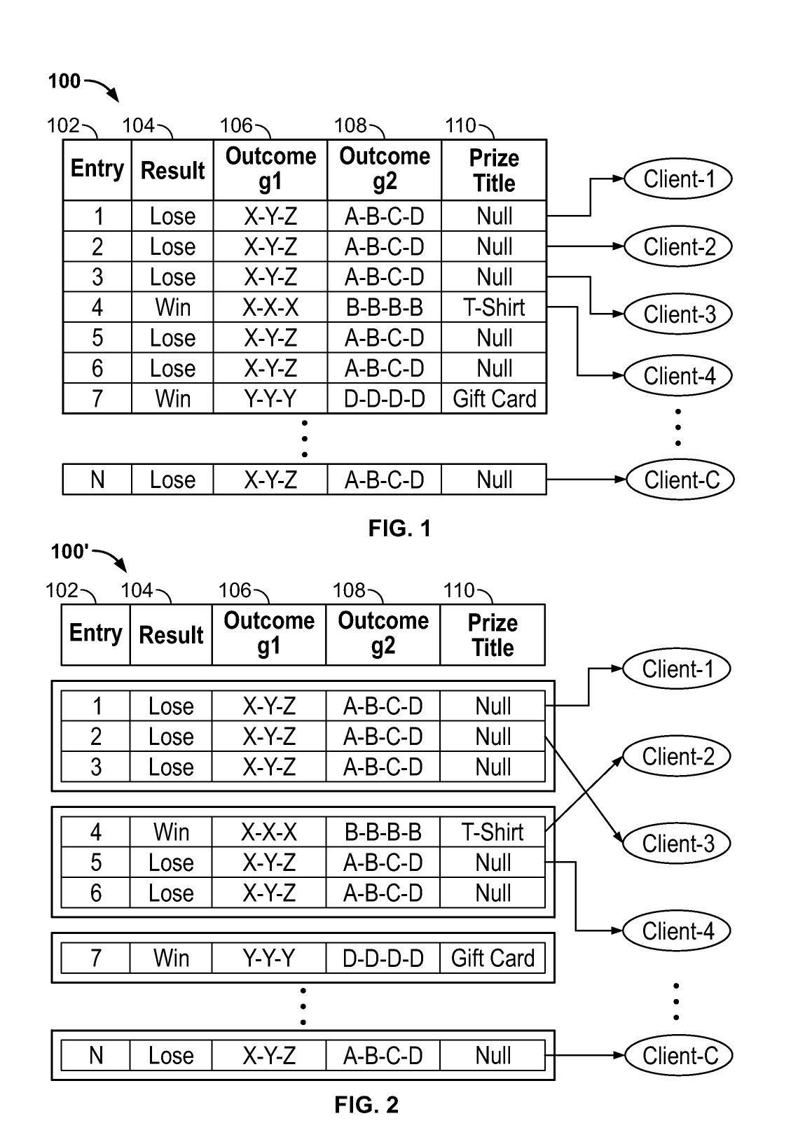

The core application, as part of an example of a way to manage a campaign, can construct a “results array” for the campaign. The results array can, e.g., contain an entry for every single participation event in the campaign, a participation event amounting to, e.g., an individual time a user seeks to be a randomly selected recipient of an enhanced loyalty program reward, such as a check-in program enhanced reward, along with the specific results of that specific participation event contained in the array. A “participation event” thus is defined by an atomic action by a user which may result in the user being randomly selected as the recipient of an enhanced reward. Collectively the entries in the results array contain specific results information about every individual possible participation event that can occur during the enhanced reward distribution campaign. Once again, it will be understood that the results array can deal with free plays in at least the ways noted above, and, e.g., have extra entries to account for the random occurrence of free plays or not. For each possible occurring participation event the results array can contain one or more of the following pieces of data: Win/Loss—Whether this participation event results in a distribution of an enhanced reward to the participant or not. Game outcome (G)—the specific outcome of the game or games. There may be multiple game outcomes specified to allow the use of the results array across a single or multiple game campaign. The game outcome (G) for a specific game type (g) resulting in a specific enhanced reward type (p) is denoted as G[g][p]. That is, a given campaign may involve the possibility of the user being randomly selected to be the recipient of one of several enhanced reward types, e.g., I, II and III, each with different odds of a participant being randomly selected as a recipient of the given enhanced reward type, and the game outcome (G) that indicates which enhanced reward is to be awarded may differ in each case. As an example, for a slot machine game, three cherries may be a game outcome related to the lowest value enhanced reward I, three bars the outcome related to the medium valued enhanced reward II and three diamonds to the highest value enhanced reward III. It will also be understood, and also as explained in further detail below, that this type of loyalty program enhanced reward distribution system and method may be made available to all users at least according to a level of merchant participation or only to users at a level of user advertising value to the merchant that may require satisfying multiple means of entry criteria or weighted combinations of such criteria at the same time. Enhanced reward—what enhanced reward type (p) this participation event results in for the user. The core application may also reference P[i], the universally unique identifier for an individual enhanced reward, e.g., also tied to the particular campaign by, e.g., the merchant and RDS server. The core application may also reference P[bi], the merchant identifier for an individual enhanced reward. Usage—after sending a result from the results array the core application may mark that entry as used and add usage details such as when the result was sent to a user and/or the merchant and/or the social network and/or friends of the user, etc. and which social network, friends, etc. it was sent to, and the like. An example of a results array is shown in FIG. 1.

The number of entries in the results array can be equal to total plays (N) and may be constructed one of the following ways. The merchant account administrator may explicitly specify a total number of plays (N). The merchant account administrator may specify the total number of entries (E) to the campaign and a fixed number of plays (n) for each means of entry (n[me]). The total number of plays (N) may be calculated from these variables as p*E=N. The merchant account administrator may specify an approximate number of entries (E), range of entries, minimum number of entries, or maximum number of entries to the campaign and a variable number of plays (n) for each means of entry. The maximum size of the required play array may be calculated by MAX(n[me])*E=N(max) for all means of entry (me), as this assumes every entrant satisfied the means of entry which resulted in the most number of plays for the entrant. Similarly, the minimum size of the required play array may be calculated by MIN(n[me])*E=N(min) for all means of entry (me), as this assumes every entrant satisfied the means of entry which resulted in the least number of plays for the entrant. Play array sizes may vary between N(min) and N(max) depending on the merchant defined entry number requirements. The core application may calculate the total number of plays (N) which satisfies the merchant account administrator's desired number of entries. For example if the merchant account administrator has specified a minimum number of entries (E), the core application must use the maximum play array size, MAX(n[me])*E, in order to guarantee the minimum number of entries is met.

As another example, the play array for a campaign could use the average number of plays per entry (n) or AV(n[me]) from a similar previous campaign. This may serve as a reasonable approximation of AV(n[me]) for this campaign. Therefore given a desired number of entries (E) the play array size (N) may be calculated as AV(n[me])*E where the average is from the previous campaign and E is from the current campaign. Other historical aspects of previously run campaigns may be taken into account in defining a given prospective campaign. The merchant account administrator may specify a target number of entries (E) and offer a variable number of plays (n) for each means of entry (me). To achieve the target number of entries (E), within some margin of error, the results array can be calculated in subsets (s) over time, each subset size adjusted by the history of campaign usage, specifically means of entry (me), in prior instantiations, or previous participation events in the given campaign. The core application may divide the play array in to (s) subsets so that the entire play array (N) consists of the sum of N[s] for all s. Each number of plays in a given subset, N[s], may be sized using trend data from previous subsets, N[s-1, s-2, . . . ]. The initial subset (N[1]) size may be calculated using N[s](max) for that subset which can be calculated as MAX(n[me])*E/s. Subsequent subsets (N[2], N[3], . . . ) may be sized using the average number of plays per participant, or AV(n[me])*E/s, over the previous subset or subsets. It can be seen that using this method a merchant account administrator may offer a variable number of participation events n for each means of entry (me) and specify a target number of entries (E). The core application, using the method outlined above, can systematically adjust the play array size in pieces over time to target the desired number of entries (E). The merchant account administrator may specify the amount of time (T) the campaign is to run, e.g., in days, and the average number of participants (E) or participation events (N) per time unit, e.g., participants per day. The total number of participants (E) or participation events (N) may be simply derived by multiplying the entered average by total amount of time (T). The results array may then be created using one of the methods noted above. The merchant account administrator may enter the odds of being selected to receive each enhanced reward type O[p] and the quantity available of each enhanced reward type Pq(p). Each set of odds O[p] may be represented as A:B where for every B participation events, as a total, a quantity A of enhanced reward p will be distributed. Using O[p] the core application may then construct a results array which ensures that on average every B number of participation events results in A number of enhanced rewards p being distributed. The core application may extend the results array until O[p] may no longer be satisfied, due to lack of additional quantity Pq[p]. At this point the core application has established the maximum size of the results array containing N number of total plays. The merchant administrator may enter the odds of winning each enhanced reward type O[p] only. The core application may then assume the quantity available of each enhanced reward type Pq[p] is some very large number or infinite. The core application may then build a large results array which satisfies the odds requirements as specified by the merchant account administrator (O[p]). Since there were only odds specified there is no way to compute total number of plays (N). The results array may be partially used or used multiple times depending on how many actual entries there are in the campaign.

It may be desirable to award users a “free play” periodically upon achieving some game outcome. For example a specific slot game outcome may result in a free spin for the user, but no other prize is awarded. These free plays may be accounted for in the results array using some preset odds of a free play. If the game will award a users free plays A times in B number of plays, the results array must be expanded by this ratio (A/B) multiplied by the base total number of plays (N′) or N′*A/B. The total size of the array then will be N′+N′*A/B=N. For example in a results array which would normally require 1000 plays, the core application or merchant account administrator wishes to offer a free play result to 1:5 plays, on average. The results array must then be expanded by 1000*1/5=200. The final array size will then be 1000+200=1200=N. After the expansion of the results array, the free plays may be treated as special enhanced rewards (p′) with a quantity Pq[p′]=A/B*N. These special enhanced rewards may be included for distribution over the results array the same as regular enhanced rewards using the procedure below. As noted above, other ways of accounting for free plays may be used, such as a free play being allocated to and awarded in a single array result.

After the core application has computed the size of the results array (number of plays (N)) from one of the above or other methods, the core application can be used to determine the quantity of each enhanced reward (Pq[p]) to be given out over the course of the utilization of the results array for the given campaign. Distributions of enhanced reward types (p) must be populated into a results array in a manner which, e.g., guarantees the following requirements are satisfied. For any enhanced reward type (p) the quantity dispersed in the results array does not exceed the quantity available (Pq[p]). The odds of being randomly selected as a recipient of a given reward (O[p]) is satisfied by the quantity of the at enhanced reward (Pq[p]) divided by the total number of plays (N) in the results array; Pq[p]/N=O[p]. The cost of the campaign does not exceed C. If the merchant account administrator has only specified the total cost of the campaign (C) and the cost of each enhanced reward (Pc[p]) the core application may recommend a quantity of each enhanced reward (Pq[p]). The core application can ensure that the product of Pq[[p]*Pc[p] for enhanced reward types (p) does not exceed the total cost (C). After recommending satisfactory quantities of each enhanced reward (Pq[p]) the core application may let the merchant administrator adjust the ratio of each enhanced reward quantity (Pq[p]) while ensuring that the ratio does not violate the following equation: for sum of all p Pq[p]*Pc[p]≦C. If there is conflicting input to the core application about the quantity of enhanced rewards to be given away over the course of the utilization of a given results array for a given campaign, the merchant account administrator can reconcile these inputs via the merchant's loyalty rewards program enhanced reward distribution system campaign account before proceeding.

After the core application has determined the size of the results array (N) and the quantity of each enhanced reward (Pq[p]) to be distributed over the course of the use of the results array, 100 in FIG. 1, the core application may then populate each entry 102 in the results array with a result 104, e.g., either a non-distribution to the user or a distribution to the user of a certain enhanced reward type (p). The array 110 may also include game outcomes 106, 108 to be displayed for the given result 104, i.e., three X's (cherries) or three Y's (bars) in a three position slot machine game and four B's (cherries) for the same win location in the array (No. 4 and four D's (bars) for the same win location 7 in the array 100. Distributions of each enhanced reward type (p) and non-distributions may be populated into the results array 100 one of several ways. The entire quantity of each enhanced reward (Pq[p]) may be randomly placed over the entire results array 100, e.g., as shown in FIG. 1. The entire quantity of each enhanced reward (Pq[p]) may be placed over the entire results array according to some pre-determined pattern, which could also result in the array 100n as shown in FIG. 1. The entire quantity of each enhanced reward (Pq[p]) may be divided into some number (s) of subsets (Pq[p][s]), 120, 122, 124 and 126 in FIG. 2, and the results array divided in to the same number of subsets (N[s]). The subset of each enhanced reward (Pq[p][s]) may then be placed randomly or per some pre-determined pattern over the associated subset of entries in the results array (N[s]), as shown for example in FIG. 2. After the core application has sized the results array (N) and determined the quantity and placement of entries of a distribution of each enhanced reward (p) the core application may determine the specific game outcome (G) which indicates the distribution of non-distribution to the user. Each game type (g) may require a different format for game outcome (G). The merchant account administrator or core application may pre-determine which game outcome G results in a random distribution of each enhanced reward type (p) for a specific game type (g). Thus for every entry in the results array which results in an enhanced reward (p) being awarded, the core application can populate the game outcome (G) for every game type (g). These specific distribution outcome entries in the results array are given by G[g][p]. For entries in the results array which result in the user not being awarded an enhanced reward, the core application may use any game result which does not match any G[g][p] for that game type (g). It will be understood that the “client” 1”-“client c” orrespond to users/participants and each entry 1-N corresponds to a participation event

Rather than pre-calculating the game outcomes per entry in the results array, the core application may choose to calculate the game outcome (G) on the fly while serving users indications of game results. Pre-calculation of the game outcome (G) is intended to enhance performance in serving users results of participation events and provide a mechanism to run a check on the to be served results of selecting a results array entry location before serving them to the user/participant. At any point in generation or post-completion of the results array, the results array may be easily compressed in to a simple hash table of winning index numbers. By storing winning entries indexed by numbers in relation to total array size, the core application may submit an index number and retrieve all relevant information only on winning entries. If there is no entry in the array for that index number, that index number (i.e. participation event) is a non-distribution event and the core application may treat it accordingly. Compression is not an option if specific non-distribution game outcomes (G) are stored in the array as well. However, non-distribution event game outcomes can also be indexed to non-distribution index numbers. Each service of the content of a results array to a user/participant seeking to be randomly selected as a rewards system enhanced reward recipient can consume one entry in the results array. Each entry in the results array can then only be used once. The core application may consume the results array in several different ways. The core application may step through the results array linearly serving users/participants one incremental entry at a time per participation event. In this case the core application may mark each entry as used as well as note which entry was the last used (served to a user/participant). The core application may randomly consume entries in the results array. In this case the core application can mark each entry as used so that the same entry can never be used twice. The core application may divide the results array in to some number of subsets (N[s]) and distribute those subsets to be served to users/participants in parallel. Those subsets may be consumed linearly or randomly per the above methods. In this case the results array is no longer centralized, however each entry is still used only once. This method may be used as a performance enhancement by removing the bottleneck of a single results array which may need to be accessed by many users participating in the same campaign. This is shown in FIG. 2.

The user/participant may be using a “client application” on a user digital communication device in order to participate in the campaign. In many embodiments the client application can be a mobile application downloaded to the user's mobile user device. Other embodiments of this method may not require a mobile application or mobile device or downloading, e.g., if the participation is hosted on the RDS and accessed by the user/participant. All client applications, however, have a network or data connection to the core application. Using the client application a user selects the representation of the game format or games formats by selecting a campaign from a merchant account on which the user would like to participate, which campaign may require the user/participant to meet one or more means of entry criteria. The merchant account may be automatically selected by the social network, the RDS server or the merchant, based, e.g., on the operation of the particular check-in or other loyalty rewards program associated with the enhanced rewards distribution system and method. Campaigns which have location requirements may not be selected for participation unless the user is physically within or perhaps within some pre-defined radius of that location. After the user has satisfied the requirements of participation (e.g., the one or more means of entry criteria) for the campaign, the core application can allow the user to interact with the selected representation of the game or games in the campaign. The core application can send all information to the client application, e.g., on the mobile user device, which affects game participation results. The user may be predetermined to be able to be served with an opportunity for a participation event involving the representation of the game one or more times, depending on how the merchant has configured the requirements of participation and the number of permitted participation events per means of entry (n[m]). This may also be randomly determined during service of results, where some results are for a free participation, i.e., not predetermined as a fixed number of plays per entry into the campaign, but effectively providing more total plays on average. Every time a user/participant consumes a participation event in a campaign a result is taken from the campaign's results array and sent to the client application. The client application then displays such result to the user. The client application may appear to the user to be generating results locally, but all results may be sourced, e.g., from the results array on the core application. Free participation results may be entered into the results array for a given campaign, effectively increasing the size N of the results array.

The core application may offer several variations beyond a single game of chance which the merchant account administrator may select. Multiple games of chance—the merchant may select more than one game of chance and allow the user to elect with which representation of the game to interact. The merchant may select a single game with multiple game outcomes signifying the user/participant of a recipient of an enhanced reward of a particular value. The results array can store multiple game type outputs (G[g] where g is game type). A user/participant participation event, resulting in the service by the loyalty rewards program enhanced reward distribution system of a participation event result, e.g., from a results array, results in the use of a single result array entry, responsive to which the client application can display the game outcome (G) of the appropriate game (g). In such an event the odds of being selected to receive the randomly selected loyalty program enhanced award may be set to be the same for each different game and the results array split between the two, or more, represented games, or adjusted dynamically to account for more selections of one game than another during the campaign. That is, the results array, as one or the other set of results entries gets closer to being exhausted, may be assigned results array outcome entries from the other less used results array, with, however the output (G) still presented for the right selected game. Alternatively the multi-game campaign may have more than one results array, one for each game, and when the entries in one are exhausted the campaign drops that represented came from the available selections to the user participant. The same could be done for a single game campaign with multiple enhanced rewards for different represented game outcomes.

Game piece—rather than each participation producing a singular chance to win an enhanced reward, the participation event may result in the acquisition of a game piece for the user. The collection of one or more specific combination(s) of game pieces can then produce a enhanced reward for the user. In this case, the results array can still store and serve a game output G, i.e., a particular piece received, but the result array entry cannot denote that output as resulting in or not resulting in a distribution, or of what level of enhanced reward, if several are in the campaign. The results array cannot necessarily so specify because it depends on the user's past participation and result history. The core application will populate the results array with game pieces (G) such that in the worst case the number of each enhanced reward given out does not exceed the number of enhanced rewards available for the campaign (Pq[p] for all (p). The worst case may be calculated by the assuming all game pieces go to a single user or at least all game pieces go to users that continue to obtain game pieces until the campaign is over. In other words, if, as noted below, the number of actual recipients of an enhanced reward depends on the recipient getting one relatively rare piece and filling in all of the other abundant pieces, that a recipient of the required rare piece does not quit before filling all of the other required pieces, or is not blocked from doing so by the results array distributing all of one type of the more abundant pieces before that user can obtain that more abundant piece, even though already possessing the required rarer piece. Other ways of managing the selection of a recipient of an enhanced reward in such a type of campaign can also be readily understood. However the RDS, e.g., may also track pieces awarded to given users/participants and estimate the total of winners in that fashion. In another variation on the game piece game, users may trade game pieces with each other. This may be done using an on-line tool (such as the core application or through the social network) or a combination of on-line tool and physical act, such as communicating a trade to the core application by bumping phones. Email or other communication used for exchanges of pieces may also be permitted. Blitz—Instead of a user satisfying a means of entry for some number of plays (n[m]), a user or users may satisfy a means of entry (me) a collectively large number of times, wait until some specified time, and then have the collectively large number of plays, perhaps even exhausting the remaining enhanced rewards (ending the campaign). It will be noted that, especially in the situations where the results array is randomly populated with awards and non-awards, all enhanced rewards may be awarded before all entries in the results array are exhausted, in which event the RDS may halt the campaign or continue until all results array entries are utilized in a serve to a user/participant of a results array entry in response to a user participation event. The user or users who have satisfied the means of entry may have knowledge of the specified time to participate or may be alerted by the core application or merchant account of the need to begin to participate to avoid the campaign closing before the blitz can be executed.

Loose Odds—Rather than fixed odds from an interaction with a representation of a game of chance the merchant may select a game(s) format with more loosely defined odds. This could be a skill based game(s) such as answering a trivia question or chance based games outside of the core application's control of the odds such as sports betting, or even actual gambling events with the real winning odds involved, such as playing black jack against a computer generated dealer, a poker hand heads up against a computer opponent, a real randomly generated scratch card, a real slot machine with odds like those in a real life casino, or other such games of chance where the RDS likely cannot and often does not pre-establish such things as the odds of an individual participation event resulting in the distribution of an enhanced reward based on, e.g., a fixed cost campaign and a given number of available enhanced rewards, etc. If the core application cannot determine a fixed ratio of enhanced rewards to participation events, it cannot construct a results array. In such a case the number of plays (N) can only be estimated for the merchant account administrator. The core application may offer the representation of the game to the user and reward a enhanced reward based on some rules set forth the by the merchant account administrator or core application by default. As an example a cap on total number of plays (N) or on the total cost (C) may be implemented for such a campaign. In such a case the core application may, e.g., monitor wins of each enhanced reward type (p) and end the campaign when the number of enhanced rewards exceeds Pq[p] or the total cost to the merchant exceeds a selected (C). It will be understood that in a representation of a game such as poker using the results array, the game result for a given enhanced reward type (p), G[g][p], having an odds of occurrence O[p], i.e., A enhanced reward recipients for every B participation events, may be, as an example, 3 aces. In such an example of the single game of poker being offered for each entry by the user 3 aces, or better, perhaps, will, e.g., appear in the results array A times for a given B participation events with total plays N when equaling A*B, and something other than 3 aces, or better, appears in the other results array entries, as served from the results array to users/participants where the result served for the given participation event amounts to a non-distribution of an enhanced reward. On the other hand, for a representation of a real game of poker, the enhanced reward may be awarded based on a winning hand of some value, such as three of a kind, which has some definable probability of being dealt in a straight up hand of some type of poker, but may not, in an actual game played against a computer opponent, be the winning hand. Thus, the user may have to get the required value of a hand, three of a kind, but also win the hand, which accounts for the odds not being pre-determinable by the RDS. However, there are also ways to, e.g., restrict the hands dealt to the user and the opponent, e.g., to some stored hands in a database or other memory accessible to the RDS, to form a given results array, and not really randomly deal the cards, in order to get back to a predetermined A number of winners per B number of participation events, known beforehand, while still giving the illusion of the real poker hands being dealt to the user participant and the computer opponent, or the hand to the computer dealer in Black-Jack, and the like. Where there are games which allow for user choice, such as blackjack, the RDS may deal stored hands and achieve a maximum A winners per B number of events. Because the user may misplay their hand and force a loss, the final ratio of A winners to B events may be smaller than the maximum specified amount but will never exceed the ratio.

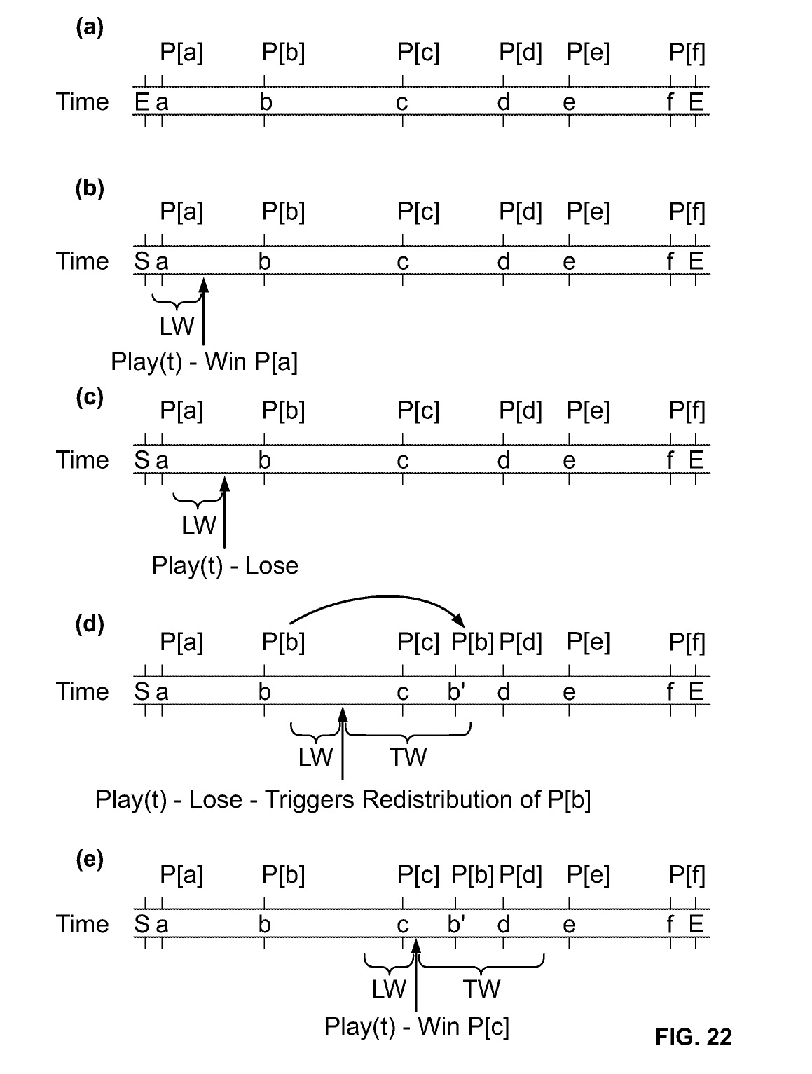

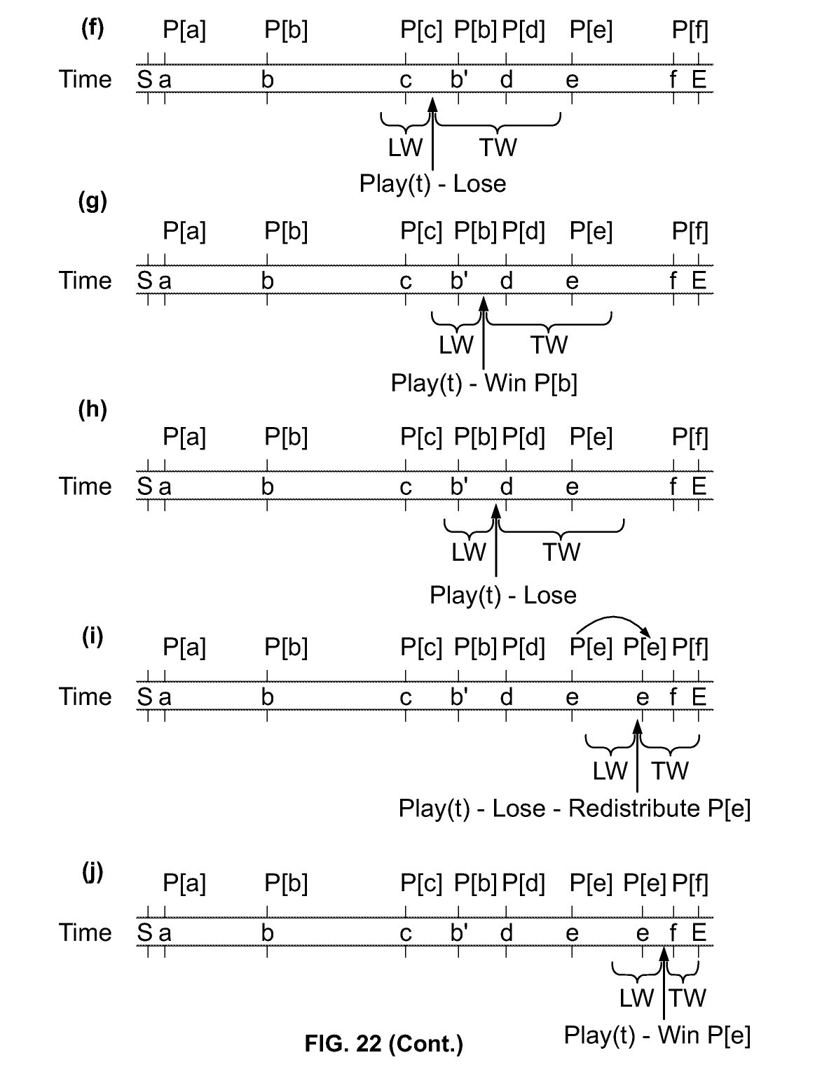

Alternatively to locking in the odds of any given campaign, it may be desirable to lock in the duration of the campaign. Locking in the odds provides a fixed cost-per-participant for the business and a fixed reward-per-play to the user. However, if there is a maximum cost of the campaign and/or limited quantities of certain enhanced rewards, the total duration of the campaign may be based solely on the participation rate. In other words the duration is not predictable. In order to address the need for a truly fixed duration campaign, enhanced rewards may be served at fixed award times P(t) which span the desired duration D. A merchant account administrator may configure the campaign duration using the merchant account on the RDS. The core application may then randomly select times for each enhanced reward P where the total number of times selected will be equal to Pq[p] for all p. Each randomly selected award time can then contain a specifically identified enhanced reward P[i]. In FIG. 22a there is shown as an example a temporally bounded customer loyalty rewards program random enhanced reward distribution system campaign lasting from a start time S to an end time E, with preselected award times. FIG. 22a shows a timeline with a start time of S, end time of E and of duration D populated with available unique enhanced rewards at random points in time (i.e., award times P[a}-P[f]). It will be understood that the times may be discrete times, such as every minute during the duration D, or time periods, such as every second or other time interval between minute m and minute m+1. If a merchant has, e.g., configured the merchant's hours of operation for the random enhanced reward distribution, the enhanced rewards may be distributed only in some or all of those hours.

In this alternative, as noted, enhanced rewards may be served to the user/participant based on the time the user/participant plays the game, i.e., a play time (t), the location of enhanced reward times P[a]-P[f] in FIG. 22, and, e.g., an acceptable window of opportunity after an award time, e.g., P[a]-P[f], called a look-back window (“LBW”). The play time t that a player engages in a participation event, can be thought of as the time the core application is requested to serve a result to that player. A player who plays at a play time (t) will also be rewarded an enhanced reward (baring a match between play time (t) and one of P[a]-P[f], if there is a reward time, P[a]-P[f], within the look-back window (LBW) which was not awarded since no player played at that particular playtime (t). FIG. 22b shows a play time play(t) where the reward P[a] is served to the player because the reward time P[a] was not previously marched by a play time (t) but is within the look-back window LBW. Such may also be thought of as a results array where the array locations are incremented in order (a form of random selection), whether or not there is a specific participation event associated with such play time (array location), but enhanced rewards are not passed over, but, rather, carried forward to the next possible chronological playtime play(t). In other words, one form of this time distribution of enhanced rewards may be to consider that the LBW is the time from the last distribution of an enhanced reward, where an intervening play occurs before one or more next award time(s) P[a]-P[f] for the next enhanced reward. If there is no unawarded (unmatched) reward time P[a]-P[j] within the look-back window the result for the player is a loss. This can be seen in FIG. 22c where there are no enhanced rewards within the look-back window at play time (t). A variation of this could occur when there are multiple rewards that have not been awarded since the last P[a]-P[f] when an enhanced reward was distributed (or since time S), in which event this can be considered to be two or more look-back windows, one looking back to the last P[a]-P[f] when an enhanced reward was distributed (or start time S) and the second looking back to the last look-back enhanced reward having been distributed, from a time occurring prior to the next scheduled award time P[a]-P[f] when an enhanced reward is pre-scheduled to be distributed.

In another variation with a fixed LBW, as an example, if a participant/user plays at play time (t) and there is no enhanced reward remaining undistributed within the LBW but there is an available enhanced reward between the start time (or the time of the last distribution P[a]-P[j], and the current play time minus LBW, that enhanced reward can be redistributed. When a play time (t) occurs where there is no reward undistributed within the LBW, the core application can check to see if there are any available rewards between the start time, S, and the play time (t)-LBW. If there is, the core application can select one or more of these available enhanced rewards (as an example the one with the earliest time P[a]-P[f] and redistribute the reward, e.g., as illustrated in FIG. 22d. As another variation, when a play time (t) is passed, without a play to which to attach an enhanced reward distribution, the core application can leave the award open forward in time between the play time (t)+(TW). A time between the play time (t)+TW can thus also be randomly selected by the core application. This time must never extend beyond the campaign end time, E, so in some cases TW will be truncated by the end time E. The previous reward time which fell before Play(t)-LBW can now be re-assigned to this new time. As noted a play time (t) which triggers a redistribution of reward P[b] is shown in 22d. More examples of plays on the same timeline are shown in FIGS. 22e-22j. In FIG. 22e, enhanced reward P[c] is awarded, since it remains un-awarded at play time (t) and is within the LBW prior to play time (t). In FIG. 22f there is no award since there is no match with the next pre-scheduled award time (redistributed award time P[b]′ and no un-awarded reward within the LBW. In FIG. 22g, while there is no match with any of the remaining award times P[a]-P[f], redistributed award time P[b]′ is within the LBW, and thus, awarded. In FIG. 22h there is no match with pre-selected award time P[d} and no available un-awarded reward in the LBW. In FIG. 22i there is no award, since award time P[e] is outside the LBW, but award time P[e] is also redistributed to between play time (t) and E, or more specifically between play time (t) and the next scheduled award time P[f]. In FIG. 22j redistributed reward P[e]′ is awarded as occurring in the LBW. It can be seen from the examples of FIGS. 22a-22j that most rewards are awarded due to having been skipped and occurring in a subsequent LBW. This can be the result of there not being a large enough number of players and/or population of reward times or from the size of the interval assigned to each successive play time(t), e.g., one second, ten seconds, 30 seconds, etc. Thus in a crowded bar or crowded mall foyer with hundreds of people engaging in participation events for the same campaign, more or less constantly throughout the duration D of the temporally bounded campaign, the probability of matching play times (t) with each or most sequential award time P[a]-Pa], as in the example of FIGS. 22a-22j increases and the uses of the LBW and TAW become less required to insure distribution of all of the enhanced rewards during the particular campaign, but not completely eliminated.

Some forms of the look-back window as discussed above can serve to ensure that if play is slow or stopped for a period of time the enhanced rewards wins won't be grouped in a big clump (“clumped together”) as play begins again. If the LBW was infinitely large and there were no plays for a long duration, some number of plays would be guaranteed back to back winners. If LBW is extremely small, it's unlikely any rewards would ever go out as play(t) could have to be extremely well timed (i.e. lucky) to get the reward. The optimal value for the LBW is related to the average play frequency (D/total number of plays). As this number can not be known ahead of time another indication of behavior may be used to compute this value. One option is using a multiple of the average reward density (D/total # rewards). For example if the average reward density was one reward per hour, a look-back window of 20%*(1 hour)=12 min could be selected. This makes the assumption that there will be significantly more net plays (in this case 5×) than the net number of rewards. After setting an initial value for the LBW, the value may be adapted over the course of the campaign. For example if the number of redistributions are over a certain threshold, LBW could be increased to reduce the number of redistributions occurring.

A throw ahead window (“TAW”) can also provide a feedback mechanism on this algorithm such that as redistributions happen, they artificially increase the reward density in the immediate future making the likelihood of a win go up. This behavior ensures that slow periods of long durations will begin to distribute rewards more often than they would have initially, because the reward density is slowly increasing. By the same token, as soon as play begins to pick up the core application will be consuming the redistributed rewards and doing new redistributions less often, thus correcting the density. Generally speaking, the throw ahead window will typically be a multiple of the look-back window. If the throw ahead window is too small, when play picks up suddenly there can be a large clumping of rewards together as many rewards will be redistributed to a very small window. The optimal value for the throw ahead window is based on future play behavior which cannot be predicted. However, here too average reward density can be used to help calculate an initial number. For example if the average reward density was one reward per hour, a throw ahead window of 5*1 hour would attempt to push the rewards in to the immediate future without creating too drastic a change in reward density. It will be understood that other approaches to rectifying “clumping” of participation events resulting in the distribution of an enhanced reward, where, as is being discussed in this example embodiment, there is a time-based distribution array/algorithm, such as combining a density factor to the look-back and/or throw ahead algorithms. That is reward distributions based on occurrence of a participation event in the respective window with multiple awards awaiting distribution may be limited to so award frequency.

Time based distribution systems/arrays may be employed, e.g., in on-location instant-win digital sweepstakes, a possible variation of the checkin based loyalty program random enhanced reward distribution system/method of the present application. Unlike some more traditional “sweepstakes” type of reward distribution systems and methods of the art, where, e.g., a relatively very few prizes are distributed and there is usually no location-based requirement, i.e., many participants may be playing from locations remote from each other, e.g., using their home computers or mobile communication devices, but in many locations remote from each other the systems and methods of the present application may be employed in location-based promotions, such as with many people together in a bar, a sports arena, a store a mall, etc. during a fixed time period, the length of a game, happy hour, etc.

The above and other similar algorithm(s) may be further optimized for serving multiple results to a single player after, e.g., a period of little or no play, e.g., during a time based distribution system or method. Implementation as described can renders play results for a single player, beyond the initial play, extremely less unlikely to produce a win, especially if the first play is a loss. If there happens to be multiple unawarded wins within the LBW, they could be awarded play after play, even to the same user, producing clumping in multiple prize wins to single users or to users grouped together by location and time. Multiple plays can be made to produce random results for each play one of several ways: the single timeline method may be used to determine whether a player is a winner or loser upon the occurrence of a participation event for the user/participant. The result (win or loss) may then be served along with loss results in a random order. For instance, if a player enters a game with 3 plays and a prize is within the LBW, the winning result will be served randomly as one of the 3 plays, and the others will be served loss results. This could also be considered the effect of the density correction factor noted above, e.g., applied on an individual participant basis. Each play (1,2,3, . . . ) may use a result from separate (or offset) timelines (1,2,3, . . . ). A simple implementation of this could still provide a degree of randomness where any single play may produce a win for the player. However, this method may still result in the clumping of multiple prize wins to single players who were lucky enough to play after a lull and there are now prizes available in both time-lines LBW. This method may be then improved by limiting each player to a certain number of wins (e.g. 1) within some time period, e.g., defined by an award density factor and serving losses for subsequent plays.

Use of an end buffer (EB) may be additionally employed to help ensure that all rewards are distributed over the duration D of the campaign, i.e., from start time S to end time E. The EB may be some fixed percentage of the total duration (D) optionally with a floor and/or ceiling on the time that the EB lasts. Rewards may not be distributed in to the EB initially and/or not redistributed in to the EB. Further, any play which occurs within the EB may employ an infinite LBW such that if there are unclaimed rewards anywhere within the campaign they will be awarded to the player and the redistribution will never take place. Use of the EB and/or multiple EBs with different characteristics can be used to help control the end of time-based campaigns which otherwise may have ended with undistributed rewards. It will also be understood that other techniques and processes may be utilized in defining the distribution of enhanced rewards during a time bounded random enhanced reward distribution campaign as will be appreciated by those in the art. To enforce participation frequency (F[m]) as defined by the merchant with the RDS in the merchant rewards distribution campaign account, the core application can identify unique users (u) by one or more methods including: a unique phone identifier from the phone manufacturer; social media account or accounts; the core application requiring that each user create a mobile application account so that it may identify users by account; network based identifiers such as email and other IP address or TCP port; mobile phone number; user account on the core application, including, e.g., a user profile with other user information valuable to merchants for real time and other focused advertising, rewards programs and the like; user account information from a merchant loyalty rewards program registration; user account information from a consumer purchase account issuer and/or transaction handler linked to the social network check-in system, to the merchant as part of, e.g., a purchase transaction made by the user/account holder in connection with the check-in, or with reward redemption, including random enhanced reward distribution as disclosed here or other merchant or consumer purchase account reward programs; user account information from a telephonic communication connection provider about the user, the user account, the mobile or other personal device of the user, etc. It will be understood that this kind of user related information may be obtained once and stored by the RDS, the merchant, the social network, the issuer/transaction handler or connection provider, or some or all of such entities in collaboration.

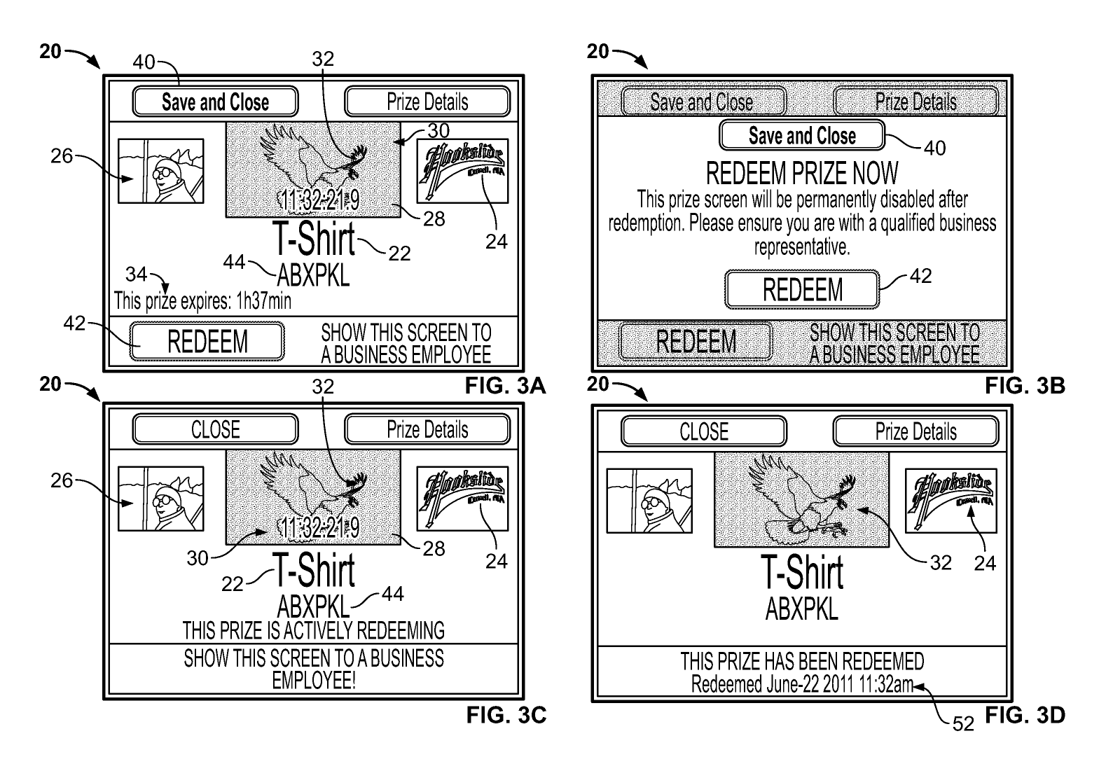

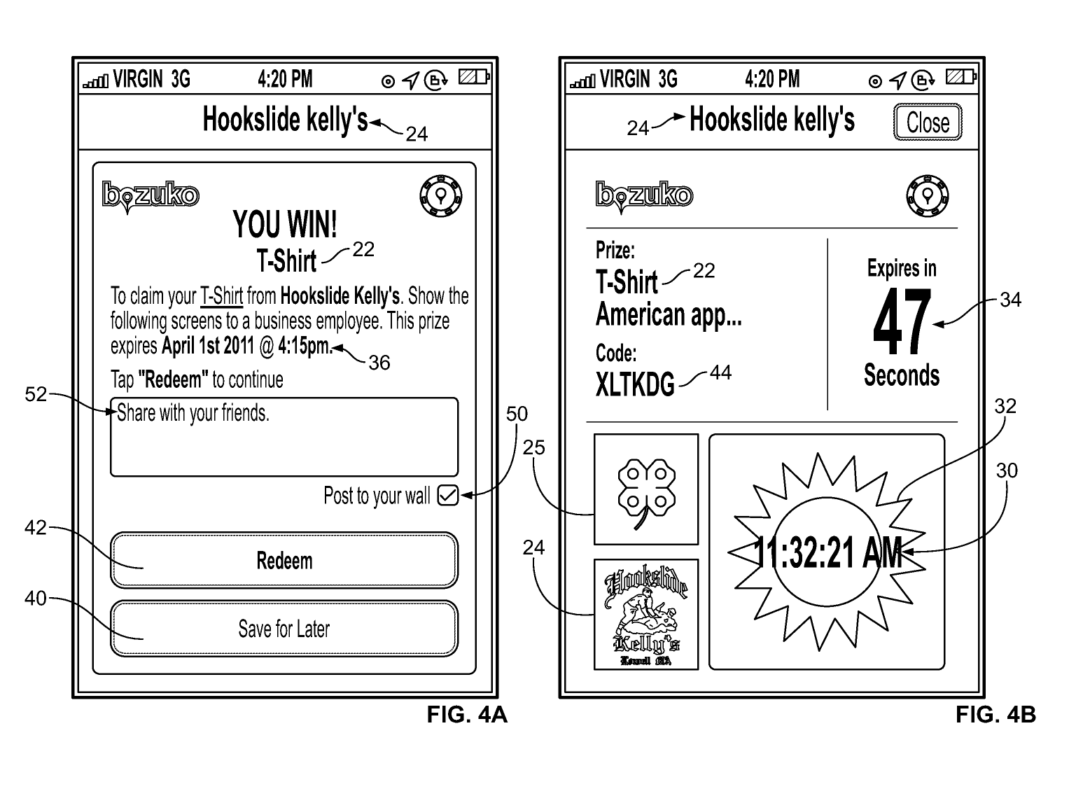

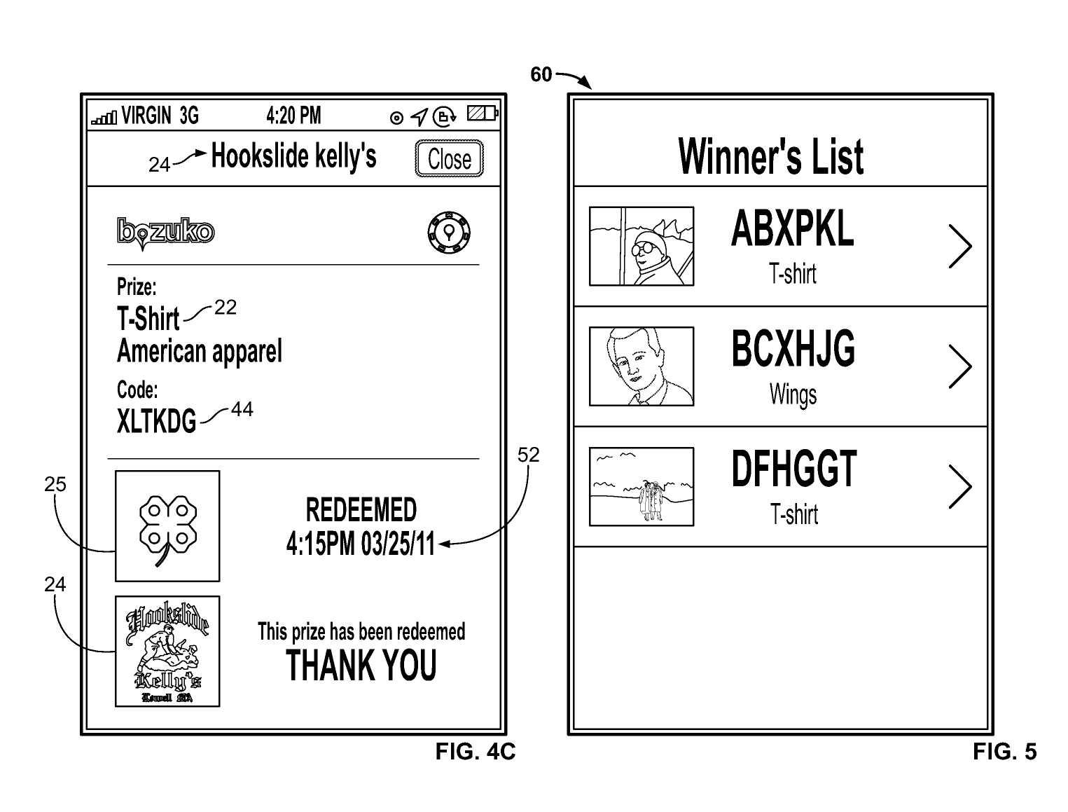

After some number of participation events, depending on the means of entry (n[m]), e.g., as considered in the campaign index in terms of user/participant promotional value to the merchant, the user's further participation may be subject to participation frequency (F[m]) limits, e.g., depending on the available means of entry or the ability of the user/participant to satisfy another previously unsatisfied criteria, such as increasing “friends” above a next higher threshold level. During one or more of the entries a user may be served an outcome result indicating the user/participant is a randomly selected enhanced reward recipient. A merchant may also have configured the merchant rewards distribution campaign account to give a user a consolation enhanced reward just for playing. The consolation enhanced reward could be one or more free plays, a one time or one time period chance to play with higher odds of getting the enhanced reward (“high chance”), or like ways to promote the enthusiasm of the user for continued participation in the campaign(s) of the merchant or the RDS. After winning any enhanced reward, including a consolation enhanced reward, other than, e.g., a free participation, a “high chance,” or the like consolation reward, the core application can record the current user as a recipient of that enhanced reward and mark the enhanced reward as “active.” The mobile application can display an “active enhanced reward screen” for the user which is used to convey to the user all of the details of what is being distributed to the user, how to redeem, as well as offer some security measures to prevent fraud. The “active enhanced reward” screen 20 may be composed of some or all of the following components, illustrated by way of example in FIGS. 3a-3d: the enhanced reward (p) 22 which is being distributed to the user/participant, e.g., “T-Shirt”; the name and/or logo of the merchant 24 from whom the enhanced reward is being received, e.g., “Hookslide” bar; the user's profile picture 26, e.g., from an associated social network (if applicable); the business profile picture or other ID 28, e.g., from the associated social network or the merchant or the RDS (if applicable); the current time 30; a unique animation 32 for that specific merchant and or merchant location, which animation subject may change on a periodic basis; the expiration time 34 of the enhanced reward; he time and date (36 in FIG. 4a) which the enhanced reward was won; button 40 to save the enhanced reward for later; button 42 to redeem the enhanced reward right now; a universally unique confirmation code 44 for that enhanced reward (P[i]); the URL of the user/recipient's portable device (not shown); the telephone number of the user/recipient's user device (not shown); a universally unique confirmation code for the user (U[i]) entitled to the enhanced reward (P[i]) (not shown); a scannable bar code (not shown); a countdown 34.

Some of the above components may also be animated. Animation and current time are anti-fraud measures that, along with other noted anti-fraud redemption process features noted herein, can prevent fraud mechanisms such as recording what is on one award recipient mobile device and displaying it on another mobile device of a user not selected as a reward recipient, absent permitted transfer of an enhanced reward as authorized, under permitted circumstances and according to defined procedures that preserve anti-fraud measures. Other aspects of the above listed items form anti-fraud measures as discussed in more detail below. The active enhanced reward screen may only be available for view for a short period of time, thus a countdown will alert the user and merchant how much time is left before the active enhanced reward screen is disabled and the enhanced reward marked as redeemed. In this embodiment the active reward screen (FIG. 3c) appears after the user has selected a redeem option 42 from an enhanced reward wrapper screen (FIGS. 3a and 3b). The user must ensure that he or she is in the presence of a specified person(s) or in a designated area, which is noted on the wrapper screen (FIGS. 3a and 3b). The user may then select the redeem button 42 and then view or display the active enhanced reward screen (FIG. 3c) before the countdown ends. Using the active enhanced reward screen of FIG. 3c and/or active enhanced reward wrapper screen of FIGS. 3a and 3b a user may elect to save the enhanced reward for later, using the “Save and Close” button 40. Enhanced rewards can be recorded and tracked by the core application on a per enhanced reward and per user basis. A user using a mobile application on the user's mobile device may access the user's saved enhanced reward(s) in a designated area of the user mobile application or other user communication/computing device or with a merchant's point of interface device. The user mobile application or other user communication/computing device, etc., e.g., with Internet access, may retrieve all saved enhanced reward information from the core application. An example of an active enhanced reward redemption process is shown in FIGS. 3a-d. A variation of the active enhanced reward redemption process is shown in FIGS. 4a-c, where there exists a wrapper screen 40, FIG. 4a, and short lived active enhanced reward redemption screen, FIG. 4b, as an example, as they would appear on a user's mobile device, e.g., cellular phone r smart phone. After the recipient of an enhanced reward receives the user's/recipient's enhanced reward from the merchant or agent of the merchant the enhanced reward is marked as “redeemed” by the core application. Enhanced rewards which are redeemed have a “redeemed enhanced reward(s) screen” (FIGS. 3d, 4c) associated with them which the users may view. Also, the social network, the merchant, friends of the user, and others, e.g., other agents of the social network, merchant and/or the RDS that participated in the campaign, e.g., enhanced reward sponsors and co-sponsors, telecommunication connection providers, merchant and other loyalty rewards system managers, including, e.g., consumer credit transaction handlers and/or account issuers, etc., all may be given access to the redeemed enhanced reward(s) screen, or otherwise be provided information about the user, the merchant and the enhanced reward, etc. Parties having access to the redeemed enhanced reward screen (FIGS. 3d 4c) or otherwise being informed of the information about the award and/or redemption of the redeemed enhanced reward may utilize the access and/or information to provide targeted and focused advertisements to the user, to friends of the user, etc. in order to promote their involvement in the loyalty reward program random enhanced reward distribution system campaign, offer advertisements/coupon and other deals, and the like.

The redeemed enhanced reward screen (FIGS. 3d 4c) may be composed of one or more of the following components: the enhanced reward (p) 22 which was redeemed; the name of the merchant and the merchant 24 loyalty reward program 25 within which the enhanced reward 22 was awarded; the user's profile picture 26 (FIG. 3d) from the associated social network (if applicable); the merchant profile picture 24 from the associated social network (if applicable); the time and date on which the enhanced reward was redeemed 52; the time and date on which the enhanced reward was distributed (not shown); a unique animation for that specific merchant 32 in FIGS. 3d and 4b, not shown in FIG. 4c, within the merchant loyalty rewards program within which the enhanced reward was redeemed; a universally unique confirmation code 44 for that enhanced reward (P[i]) 22; he method and details of redemption (not shown); the URL of the recipient's portable device (not shown); the telephone number of the recipient's device (not shown); and a scannable bar code (not shown).

If a user is randomly awarded a loyalty program enhanced reward and it is not redeemed in the amount of time as specified by “reward expiration time” 36 the reward may be marked as “expired” by the core application. Reward redemption time 36 can be defined by the merchant using the merchant's random enhanced reward distribution system campaign account on the core application. Expired/Redeemed enhanced rewards have an “expired enhanced reward screen” (FIGS. 3d, 4c associated with them that the users may view. The expired enhanced reward screen may be composed of one or more of the following components: the enhanced reward (p) 22 which has expired; the name of the merchant 24 from whom the reward was to have been received; the user's profile picture (26 in FIG. 3d) from an associated social network (if applicable); the merchant profile picture 24 from the associated social network (if applicable); the time and date which the ability to receive the reward expired (not shown); the time and date which the reward was granted 30; a unique animation 32 for that specific merchant applicable when the reward expired; a universally unique confirmation code 44 for that enhanced reward (P[i]); the URL of the recipient's portable device (not shown); the telephone number of the recipient's device (not shown); and a scannable bar code (not shown).

The core application can store data on each individual enhanced reward (P[i]) distributed to a user (u). When a user (u) is randomly selected to receive the enhanced reward (P[i]) from a merchant, the core application can store information for future use including: the unique identifier of the user (U[u]), thus only the RDS server has access to such unique identifier for users in the loyalty rewards program enhanced reward distribution system campaign being run by the RDS for the merchant, and particularly for users that have been randomly selected to receive the loyalty rewards program enhanced rewards through the campaign; the universally unique confirmation code for that enhanced reward (P[i]) including all associated enhanced reward information (details, expiration time, etc.); the name of the merchant and universally unique identifier of the merchant from whom the reward was received (B[b]), thus, once again, only the RDS can match the unique identifier for an enhanced reward (P(i)), with both the unique identifier for the merchant (B[b]) and the unique identifier for the user recipient (U[u]), and thus, only the RDS server can generate the “active reward” screen, “expired reward” screen and “redeemed reward” screen, and perhaps most importantly, only the RDS can generate both the “active award” screen and the derived “recipient's” list, 60 shown in FIG. 5 as an example, for a particular enhanced reward for given merchant and given campaign and the recipient, so that, for security reasons, the user/recipient, the particular enhanced reward and the merchant reward grantor (and particular campaign) can be uniquely linked together at the merchant when the user/recipient seeks to redeem, e.g., using an active reward screen, which the merchant only can check against a recipient's list 60 generated specifically for the particular merchant. And, only the particular user/recipient matches the user ID on the active reward screen, e.g., FIGS. 3c and 4b for a given unique distributed enhanced reward. Also noted may be the time the reward was made; the current state of that unique reward (active, redeemed or expired); the URL of the recipient's portable device; the telephone number of the recipient's device; and, the email address of the user/recipient.

Enhanced rewards may be redeemed one of several ways depending on enhanced reward type and merchant or user preference. A enhanced reward may be redeemed, e.g., using an active enhanced reward screen, e.g., FIGS. 3c and 4b. A user/recipient who has been randomly selected to receive a loyalty rewards program enhanced reward through a loyalty program enhanced reward distribution system according to aspects of the presently disclosed subject matter and has the active enhanced reward screen, e.g., FIGS. 3c and 4b, displayed on the user's/recipient's mobile device, may show a merchant employee the active enhanced reward screen, e.g., FIGS. 3c and 4b indicating that the user/recipient has been distributed the enhanced reward. The merchant employee or a user in the view of a merchant employee may interact with the enhanced reward screen, e.g., FIGS. 3c and 4b or enhanced reward wrapper screen, e.g., FIGS. 3a and 4a, such as by tapping a redemption button some number of times or entering a specific code or some other manner of exercising a redemption function. This interaction can mark the enhanced reward as redeemed and the active reward screen can then become a redeemed reward screen, e.g., FIGS. 3c and 4b. The merchant employee or other agent of the merchant can then provide the recipient/user with the reward or, alternatively, can provide the user/recipient with a merchant or other token or coupon or credit or the like for the user/recipient to actually physically pick up the reward at a later time.

An enhanced reward may be redeemed using the “reward recipients list,” e.g., 60 shown in FIG. 5, for a merchant application which uses the core application's stored reward data. All active rewards can be identified by the core application. The location of the user may also be identified by the core application. Thus the core application can present the “reward recipients list” 60 to the applicable merchant, which can be accessed only by the merchant, e.g., at the merchant location, e.g., by the merchant account administrator, via the merchant loyalty rewards program enhanced rewards campaign account on the RDS. The “reward recipients list” 60 may be presented to the merchant administrator using a computer or mobile device which is connected to the Internet and logged on to the merchant campaign account. It will be understood that, for convenience, the merchant account administrator may distribute the reward recipients list within the merchant location for merchant employees to utilize in redeeming enhanced rewards. The reward recipients list of recipients of enhanced rewards may be presented to the merchant account administrator as a list of distributed enhanced rewards for the merchant and more specifically for a given enhanced reward distribution campaign. Each entry in the list may contain unique identifiers such as user profile pictures from the associated social network (if applicable) and/or a unique enhanced reward identification code (P[i]), but perhaps most importantly, the unique recipient identification (U[u]), which only the RDS can match to the unique enhanced reward (P[i]) for the particular campaign of the unique merchant, for purposes of providing the reward recipients list to the merchant, can ensure, with other measures, the integrity of the redemption process. Non-unique identifiers, such as the name of the enhanced reward (p), may also be listed. Unique identifiers presented to the merchant administrator on the recipients list may also be present on the user's active enhanced reward screen, with the exception, perhaps, of the unique identifier for the merchant, again for redemption process security reasons, as noted above. This can provide a security cross check to associate a unique merchant recipients list entry and a unique active enhanced reward screen and thus a unique enhanced reward recipient.

Faced with a user/recipient with an active enhanced reward screen, the merchant account administrator or other merchant employee(s) with access to the rewards recipients list for the merchant and, specifically for the particular campaign, may use the rewards recipients list to first confirm that both the user/recipient is a recipient of a particular enhanced loyalty program reward and the particular enhanced reward, indicated on the user/recipients “active reward” screen, are not fraudulent. Users with an active enhanced reward screen displayed may be highlighted or otherwise promoted in the recipients list. A merchant administrator, or other merchant employee(s) may also redeem the enhanced reward that the user/recipient has been awarded by, e.g., on the hosted recipients application page, running, e.g., on the RDS server, selecting the user/recipient in the recipients list, e.g., unique to the merchant's loyalty program enhanced reward distribution campaign account, and selecting a redeem option.

The merchant account administrator may provide for access to another merchant employee(s) in one or more locations within the merchant's establishment for such interfacing with the recipients list. By redeeming an enhanced reward using the recipients list application through the merchant loyalty program enhanced reward distribution system campaign account the merchant account administrator will have marked the enhanced reward as redeemed for that reward and for that user. The user's active reward screen can then be transitioned to a redeemed reward screen. Since the entire confirmation and redemption process, or at least several important security features, can be performed only through the core application on the RDS server, the possibility of fraud is reduced. An example of a reward recipients list is shown in FIG. 5. Receipt of an enhanced reward may be indicated in the form of a displayed encoded bar code on the user's mobile device. The bar code may be stored on the core application and sent to the client application as part of a reward screen, which, as noted above, can be provided only by the RDS server for the unique enhanced reward, unique user/recipient and unique merchant campaign account. The bar code may then be scanned by the merchant or merchant employee(s) at the merchant location or some other independent redeeming entity at the merchant location or elsewhere, acting as an agent of the merchant, or of the RDS, for enhanced reward redemption. The duplicate of the bar-code or the decoding of the bar-code may also have been provided to the merchant by the RDS. As an example, the RDS provider may have an enhanced reward redemption location, such as a kiosk in the participating mall or other multi-merchant facility, and redeem enhanced rewards based on the unique bar code, or the bar code and the reward recipients list information. The bar-code may appear on the reward recipients list for the unique enhanced reward.

An enhanced reward may be emailed to the recipient by the merchant or the merchant's agent or the core application. Enhanced rewards such as electronic tickets, access codes, bar codes, and other electronically transferrable rewards may be sent to the user/recipient upon the distribution of the reward. If the core application has access to the user's email address, from an existing account, the reward may be emailed immediately and the reward marked as redeemed. The reward screen can then be immediately transitioned from an active reward screen to a redeemed reward screen. If the core application does not have access to the user's email account the mobile application may be utilized to prompt the user/recipient for the user's/recipient's email account and then email to the user/recipient the reward, or an equivalent of the reward screen or some other token/coupon or other means for the user/recipient to be able to obtain the reward from the merchant or agent of the merchant. After successfully emailing the reward to the user/recipient the reward can be marked as redeemed and the award screen can be transitioned from an active reward screen to a redeemed reward screen. An enhanced reward may be mailed or physically shipped to the user/recipient by the merchant or agent of the merchant, or, in cases as noted below of sponsored or cosponsored reward items, the merchant affiliate/sponsor providing or funding the reward. Physical objects can thus be mailed to the user/recipient some time after being awarded the reward. The core application may already have access to the user's shipping address, but may require the user to confirm that address. If the core application does not have access to the user's shipping address the user recipient may be prompted for a valid shipping address and the core application can store that address for use by the merchant to ship the enhanced reward. After the core application has confirmed a valid shipping address for the user/recipient of the reward, the reward may be marked redeemed and the reward screen can be transitioned from an active reward screen to a redeemed reward screen.

Enhanced rewards may be given to users in the form of enhanced reward tokens, similar to industry reward “miles” or “points”. A user may be awarded some number of enhanced reward tokens after a non-distribution participation event and/or an enhanced reward distribution participation event. Different game outcomes may result in a different amount(s) of enhanced reward tokens awarded to the user. These enhanced reward tokens may be accrued for a single merchant, a group of merchants or across all merchants through the RDS. Because of this fragmentation there may be one or many types of enhanced reward tokens available to users for accrual. Some number of enhanced reward tokens may then be exchanged by the user at a merchant or by the use of an online portal or mobile application for a designated enhanced reward or the ability to select from a group of available enhanced rewards. For example a user who has accrued 1000 enhanced rewards tokens of a certain type may be able to exchange those tokens online for a free hotel stay (1000 tokens), $25 gift cards (100 tokens), or an mp3 music player (500 tokens).

The core application may facilitate multiple parties participating in a single campaign where one subset of parties administrate a campaign (campaign managers) and another subset of parties provide the rewards, assuming the reward is a physical item, a good, or a defined provision of a service, a service, (reward providers) distributed to users. The core application may facilitate this differently depending on reward type and redemption method. If the reward provider is reimbursing the campaign manager for goods/services given out, the core application can facilitate the transaction between the reward provider and campaign manager. The core application can collect information on all rewards given out (P[i]), including the cost of the enhanced reward to the campaign manager (Pc[p]) and the total number of that reward type (p) distributed by that campaign over some time period. The core application may then charge the reward provider Pc[p] for each reward so distributed by that campaign over some time period plus perhaps a transaction fee. The core application can then credit the campaign through some means in the amount of Pc[p] for every reward (p) distributed by that campaign. If a reward provider is providing rewards which are intended to be emailed from the reward provider to the campaign, such as a brand name athletic shoe manufacturer coupon or other certificate for the purchase of designated model or any model of the manufacture's athletic shoe at a particular merchant location, which is conducting the loyalty rewards program enhanced reward distribution campaign, the core application may enable the reward provider to upload email contents to the core application. The email contents can then be disseminated to user/recipients of an enhanced reward through the campaign. Email contents may include documents of any sort to be attached to the email, text to appear in the email, or pictures/graphics to appear in the body of an email, etc., allowing the user/recipient to recover the reward provided by the reward provider.

If a provider is providing rewards which are intended to be shipped to the reward recipient(s) of that reward within the campaign, the core application can supply the reward provider with the address and reward information of the recipient. If the core application does not have access to the shipping address of the recipient, the mobile application may prompt the user for their shipping address information and supply the core application with that information. If a reward provider is supplying rewards which are intended to be given out at a location or locations, e.g., of the merchant or other location(s), such as at an agent of the merchant, the merchant account administrator may supply the reward provider with electronic or physical delivery locations for those rewards.

Users may be required to somehow acknowledge the reward provider, e.g., in a means of entry, such as specifying the reward provider name in a required check-in message or “liking” the reward provider on Facebook, or the like, or after the reward, e.g., by permitting the notice of the user/recipient being granted the reward to specifically identify the reward and reward provider, e.g., to the user's/recipient's social network friends. The user of the mobile application may view all of the rewards that the user has been awarded. When viewing each reward, the reward can be noted as active, redeemed or expired. A user may select any of the rewards that the user has been awarded and view the reward screen for that reward. The reward screen can also respectively show an active, redeemed or expired reward screen. A merchant may elect to provide customers with a unique code number which the user may then use to participate in a designated loyalty rewards program enhanced reward distribution campaign at another time or place. The user could then log-in to the core application on-line or use the user's mobile application and mobile user device to enter the coupon code provided by the merchant. By entering the unique code and satisfying any additional requirements of participation the user could be allowed to participate in the merchant loyalty reward program enhanced reward distribution campaign. The coupon code could be the exact same coupon code that the user received normally for the loyalty program currency, i.e., for the discount X on a subsequent purchase at the merchant as the normal reward for, e.g., a check-in or a “like” or a combination of the two, which the user can then, at some later time, use for access to participation in the merchant loyalty reward program enhanced reward distribution campaign. This system allows users to satisfy all of the requirements of participation in the campaign, including visiting a merchant location, but be allowed to actually participate at another time, elsewhere, or on a device other than mobile user device, such as a personal computer or table top PC at home or similar location not involving use of a user mobile device. Before, during and after participation users may have the option to perform actions on a social network or other online communication network or mechanism regardless of any requirements of participation. This can allow users to optionally share their activity with others who may view their communications using the specified network or mechanism. For example in the case of Facebook, users may optionally post status to their friends describing their campaign participation activity, reward status and general commentary. These posts could be independent of any check-in requirement or other Facebook or other social network related requirement.

The core application may host its own social network such that participants in any loyalty reward program enhanced reward distribution campaign hosted by the core application may communicate with other such participants of the same campaign or any campaign being hosted on the RDS server, such as, on the social network hosted on the core application. Users may communicate with select users of the core application or users may broadcast or post messages which are universally readable regarding certain campaigns, locations, merchants or other related subject matter. This could include blogs, chat rooms or other social or social-type networks hosted by or supported by or partnered with the RDS server. The RDS server may provide other typical on-line products and services to users of the merchant loyalty rewards program enhanced reward distribution system, such as Email, browsing, search engines, contacts lists (which may substitute for or compliment the friends contacted during the campaign as noted herein), news, maps, etc. Such a social network and associated on-line functionalities, including browser and email capabilities can form the communication network used by the RDS server to implement aspects of the above noted customer loyalty rewards program enhanced reward distribution system and campaigns therein by the RDS server. In order to facilitate such social network participation and social network utilization and social network supplementation, users can be identified by a user identification which they can create on the core application, e.g., using their mobile application or by logging in to the core application using another internet connected device. Users may also use pre-existing identification from another social network which allows such authentication, such as a Facebook. In any event, the RDS core application can in this fashion establish a universally unique identifier, which may, e.g., start out as the social network account identifier, but transfer to an RDS universally unique identifier, for purpose of participating in loyalty rewards program enhanced reward distribution campaigns being carried out using the RDS server, or import friends from an existing or pre-existing social network list of friends, having some degree(s) of social distance from the user, existing or pre-existing address book(s), contacts list(s), etc. which allow such import, such as Google contacts, and may continue to update such a list maintained on the RDS server in an appropriate RDS on-line account for the user.

The RDS may include a consumer credit payment system issuer and/or transaction handler functionality such that the RDS may accumulate user and merchant information, e.g., through the users or merchants enrolling to obtain consumer payment accounts with the issuer/transaction handler implemented on the RDS server or related server(s), and the RDS may also store user profile information similarly obtained and transaction information, all of which may be used to enhance the functionalities noted above of the customer loyalty rewards program enhanced rewards distribution system discussed above. Indeed, the RDS may have its own customer loyalty rewards program for users partaking in the enhanced rewards distribution campaigns, using a consumer payment account for a consumer payment device issued by the operator of the RDS server or for which the operator of the RDS server is a transaction handler, as is well understood in the consumer payment industry.

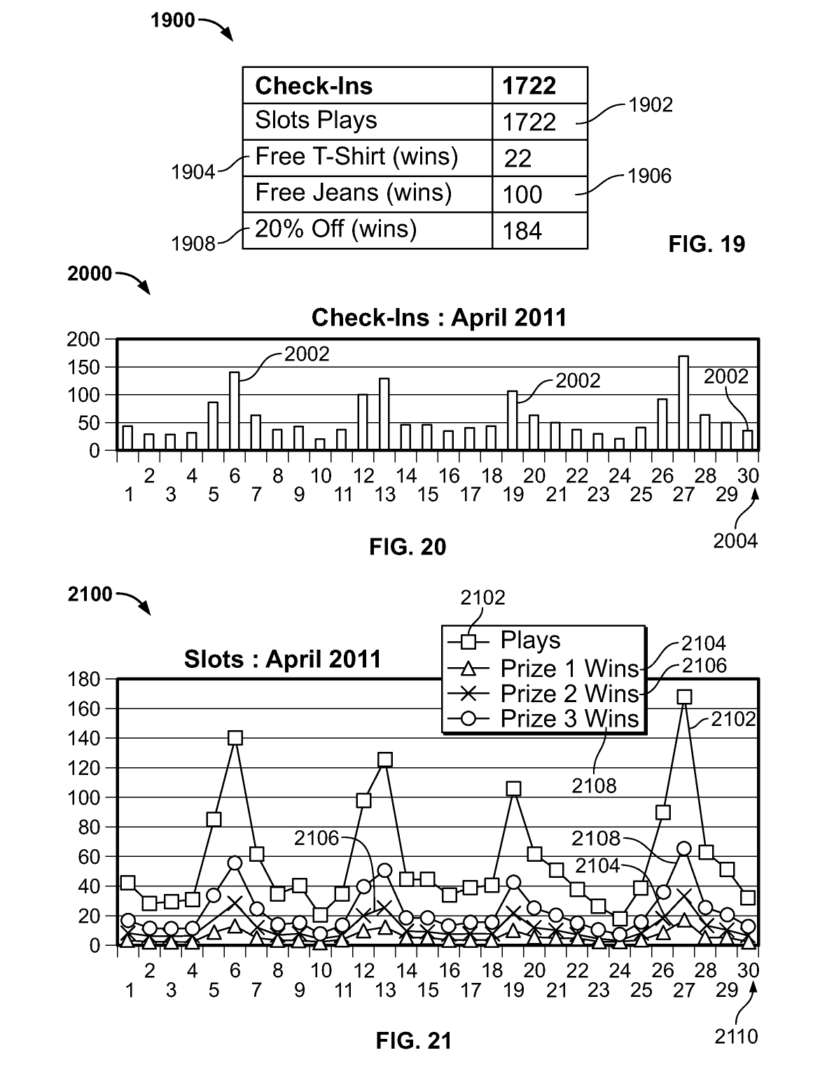

Participating merchants can receive a full and detailed report of any and all activity related to any loyalty rewards program enhanced rewards distribution system/campaign which involves the merchant in any way. This report may include, as illustrated by way of example by the charts of FIGS. 19, 20 and 21, any and all of the following: individual participation events—the user, time and result of each user participation including awarded rewards for each individual program/campaign; rewards—the users who have become a recipient of an enhanced reward, what the reward was, and the reward status and history of “active”, “redeemed” or “expired;” social network activity involving the campaign or merchant location or both, which was facilitated by or passed through the core application (including social network activity on other social networks, such as Facebook, as well as any social network contained within the core application, e.g., for each campaign and each participation event, the merchant may be notified of the means of entry factors, i.e., how many friends were notified of the “check-in,” how many friends were notified of the “like,” whether these individuals have been specifically identified to the merchant and, e.g., received a focused targeted advertisement with the notice, were they also notified of the participation event, e.g., “Your friend Jake is participating an a Bozuko enhanced reward distribution event for the Burlington Mall for the chance to win a Patriot's T-shirt,” and the result, e.g., “Jake just won the T-shirt!”, or any other opportunity to use the social network list of “friends” or any other list of addressees associated with the user participant, for notification of campaign participation events, and the opportunity for and provision of focused advertising distribution through the activities within the loyalty rewards program enhanced rewards distribution campaign, and the like possible advertising benefits to the merchant, the social network, reward providers, etc.; a graphical representation including all participation events, distributions of an enhanced reward of a given type, participation events not resulting in the distribution of an enhanced reward and social network activity graphed over a period of time to show levels of activity of the types of activity noted above over that time period; a summary table of all activity including all participation events, rewards by reward type, participation events not resulting in the distribution of an enhanced reward and social and other network activity, such as noted above, over a given time period; the contact information, if provided or allowed to be accessed, of each user participant (e.g., contact information may be a user-ID, email address, phone number, mailing address or other individual contact information, and may even include more detailed user profile information received from the user, provided from the social network, provided from the connection provider from information about the user collected during enrollment for the user communication device account or from subsequent usage of the account, if available, and provided user permission is obtained, if needed, or user purchase device account usage information available, e.g., from an issuer or transaction handler for an issuer of the consumer credit device, such as a credit card account, if available, and with permission of the user, if required, and similar information from friends and other social and other network “friends” and “friends of friends,” etc., if available, and if permission is received, if needed, etc.; a history, summary and graphical representation of each user's activity including participation events, rewards by reward type, other participation events with no reward distribution and social network activity, such as is noted above (which may also contain a list of all other users, contacts or social network connections (i.e. “friends,” “friends of friends,” contacts,” “followers,” etc.) which the user contacted or were contacted on behalf of the user upon participating, being selected for an enhanced reward, not-being selected in a participation event or arriving at the location, etc.; total enhanced rewards per user/participant from the merchant campaign as calculated in dollars or other currency by both cost to the merchant (Pc[p]) as well as retail price (Pu[p]); total cost of the campaign and such total cost broken down by other forms of measurement of success, cost/participation event, cost per/check-in, cost/per contact notified (including separately or in total, notifications of the check-in, the participation event, the result of the participation event, the redemption of an enhanced reward, etc.), cost per coupon/advertisement delivered to the participant and friends/contacts, etc.

A campaign may be opened to advertisers or representatives of advertisers for the purpose of providing targeted and focused advertising to participants and friends and others that are notified of the activities of participants. this may be made open for placement bidding as is well understood in the art and the merchant and/or RDS service provider may charge the advertisers or representatives of the advertisers for placing advertisements along with such notifications as that the participant checked-in, selected a particular representation of a game for a particular prize, played the game, won or did not win the particular prize, etc. As is well understood in the art, there are a number of ways the advertisers or advertiser representatives may be charged for such pay for performance advertising, such as per check-in, per subsequent event notifications, per friends notified of the check-in and/or any of the subsequent events notifications, per total number of friends notified, etc. This can also include, as noted above, advertisements going to the individuals and entities being so notified, and further, therefore, enhance the bidding prices from the advertisers and/or representatives of the advertisers.

Multiple co-located merchants may participate as a group under one or multiple distribution campaign accounts using one single distribution campaign or one single location such as a mall, airport, shopping plaza or other co-location of merchants. A single set of participation requirements may cover multiple campaigns or multiple rewards within a single campaign, which may be redeemed by one or more merchants within the group. A single merchant campaign account may be created for the group or multiple merchant campaign accounts may be linked to the same location or participation requirements, or be open end by each merchant in the location of the multiple co-located merchants, e.g., at a mall, stadium, arena, shopping plaza, airport, park, resort area, etc. Chain businesses (franchises) may participate as a group under one or multiple loyalty rewards program enhanced rewards distribution campaigns/accounts providing access to participation in a campaign or multiple campaigns at all participating chain locations. Participating locations may provide enhanced rewards to users individually or may have the rewards provided by a chain owner/franchisor. The chain owner/franchisor may be both the reward provider and campaign administrator of the campaign. Alternatively, individual merchants may be the campaign administrators of individual campaigns while the chain owner/franchisor may be the reward provider or sponsor part or all of the reward. Merchants may administrate multiple related or unrelated campaigns via their campaign account(s). For example a merchant may have a different campaign or multiple campaigns, e.g., according to a loyalty rewards program enhanced reward distribution matrix discussed below for different merchant locations. Alternatively, the merchant may have different campaigns making up one distribution matrix for certain types of enhanced rewards, different campaigns making up one distribution matrix for certain types of customers (separate from the criteria used for matrix, e.g., customer levels discussed below) regular, gold and platinum or similarly rated customers, or different times of the week or seasons of the year, etc. The core application may charge all participating merchants through their campaign account(s) or third party businesses through their affiliation with participating merchants, such as connection providers, transaction handlers, consumer credit account issuers, etc. The core application may issue a charge per participation event, per enhanced reward distribution or per satisfaction of a particular means of entry by a user. These charges may be accepted by the merchant according to the levels of merchant commitment as with the distribution matrix discussed below. The core application may charge a fixed periodic fee for usage of the core application such as a monthly fee per campaign account. The RDS server and campaign provider may charge some combination of the above. The RDS server operator may reduce fees or grant extra participation events for users and merchants who enroll in the RDS social network, or use the RDS as an internet service provider, or for an email account, browser/search capability, etc.

It will be understood that the above outlined merchant customer loyalty reward program enhanced reward distribution system may apply to virtually any form of customer loyalty reward program or any other form of customer marketing programs, which will be considered to come within the definition of “customer loyalty rewards program” for purposes of this application. Those skilled in the art will understand that the customer loyalty rewards program typically deals in a loyalty program reward “currency.” For example, if you fly one thousand miles you get one thousand frequent flyer “miles.” If you spend a dollar on your credit card you get a “point.” Spend a dollar on your merchant store card and get a “point.” If you spend five hundred dollars at the grocery store you get a coupon for $50 off the next purchase. Buy ten sandwiches at Natale's Deli™ or five coffees at DunkinDonuts® and get the next one free. Buy one suit at the haberdashery chain store and get one free. This even can apply to other types of customer loyalty discounts, such the monthly featured sandwich at SubWay®. In fact any program offering any kind of rewards “currency” of the kind noted above, or any other discounts, special incentives, “buy-one get-X” and like promotions and offers meant to attract new and/or keep existing customers to maintain or enhance sales volume, to attract customers during “down times,” days, seasons, etc., will be understood to be a “customer loyalty rewards program” as used in this application. The customer loyalty program enhanced rewards distribution system and method of the present application may be used in each of these cases. Thus, the “miles,” “points,” “next one free,” discounts and the like are the customer loyalty reward program “reward currency.” This can include on-line purchases, so that a check-in for some or all of these customer loyalty rewards programs may include a “check-in” that does not require the customer to be in a certain location, a “location check-in.” Rather, it may simply be required that the user is participating in some form of a customer “loyalty program” as outlined above and be identifiable to the merchant. Linkage to a social network environment may or may not be required also.

The systems and methods of the present invention can allow the merchant to “jazz-up” the ordinary customer loyalty rewards program with a system and method as described herein, where, e.g., instead of giving every customer a reward of X, give one in ten a reward of 10×, or one in one hundred a reward of 100× and so forth, or some combination(s) thereof. Thus the provider of the customer loyalty rewards program, a merchant, a mall, a chain of stores/restaurants, a consumer purchase device account issuer or transaction handler, etc., can utilize the systems and methods of the present application through the RDS server or together with the RDS server. Thus, e.g., at the end of the month, e.g., a holder of a Sears® card could take one thousand points in the Sears® card account and participate in a consumer loyalty rewards program enhanced reward distribution campaign for Sears® and perhaps get awarded an enhanced reward of ten thousand points. Sears could break even, apart from internal administrative costs and whatever fees the RDS charges, by awarding the ten thousand points to one in ten participants, and at the same time generate publicity by, e.g., touting the successful participants and the goods and/or services in turn bought from Sears® with the enhanced reward points. Regarding straight discounts, the purchasers at SubWay, as an example, could pay the full price for the monthly featured sandwich and be entered into a customer loyalty rewards program enhanced rewards distribution campaign as discussed herein, for an enhanced reward of a free sandwich on the spot or the next time purchasing, for a week's worth of free sandwiches or for sandwiches for a catered party for 12, etc. Indeed, the customer may simply “check-in” to the RDS, e.g., by logging on to the RDS server, to play a representation of a game of chance or the like as discussed in this application, with or without notification of others, e.g., through the social network, and with or without linkage to a particular merchant or multiple merchants or brand manufacturer, to help the RDS service provider promote, e.g., utilization by merchants and others of the RDS service providers services.

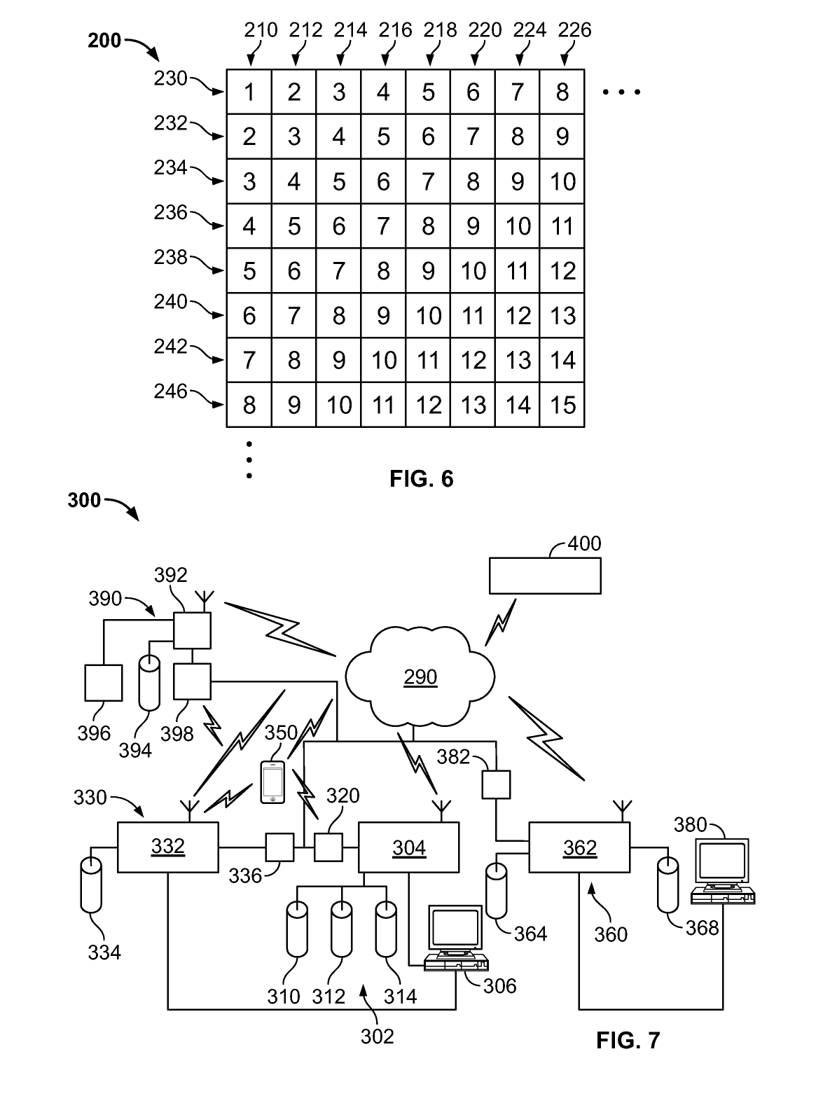

It will be understood that the contractual relationships and arrangements between the participants of the above outlined merchant customer loyalty reward program enhanced reward distribution system and method may be many and varied, however, as an example only, and with some simple formulas used, to keep the explanation more simple, a loyalty program enhanced reward distribution matrix useful in employing the customer loyalty rewards program enhanced reward distribution system according to aspects of embodiments of the disclosed subject matter is disclosed in regard to FIG. 6. FIG. 6 shows a chart amounting to a loyalty program enhanced reward distribution campaign matrix 200, in which the horizontal axis represents levels of merchant campaign participation commitment, and the vertical axis represents levels of user/participant value to the merchant campaign administrator, e.g., as a recipient of advertising or a channel for providing advertising to others. Thus in the first position column 210 and the first position of row 230, there is represented a base level of merchant campaign participation commitment. As an example, the merchant for purposes of the first position in column 210 may be willing to commit to a basic campaign of an enhanced reward of ten times the usual customer loyalty reward program reward, which can then be awarded to one in ten participants. Thus, if the usual reward is a one dollar coupon, the merchant can agree to give out ten rewards of ten dollars each for every one hundred participation events per day. Thus, the merchant is out only whatever internal costs are incurred in setting up and administering the campaign, from the merchant's perspective, and also the fee from, e.g., the RDS. It will be understood, or course, that more participation could cost even less, i.e., compared to a “normal” check-in rewards program where the merchant awards everyone checking-in a one dollar off coupon. Even assuming that not everyone redeems such a coupon, should the merchant select a campaign for only one hundred participation events each day, and the check-in notifications continue to occur beyond one hundred per day, these are in effect “free” advertising events for the merchant.

This type of a campaign can then be made available for the “basic participant,” in one example a user who has “checked-in” at the merchant's location, without more, e.g., the user qualification meets no other means of entry as noted above. Thus, in this case, as an example, the merchant agrees to fund the awarding of ten enhanced rewards of ten dollars each per one hundred participation events a day, and a “results array” for each day would have one hundred entries for the number of allowed participation events B, for which ten entries (A) would constitute the number of enhanced awards. When the allowable number of participation events (100) was exceeded in a given day, the enhanced reward campaign for that day would shut down. This then, by way of example, constitutes a level 1 campaign in the first spot in column 210 and the first spot in row 230. For the second position in row 230, i.e., the first position in the second column 212, perhaps the merchant has noticed that the allotted daily plays are exhausted before noon, or has seen an uptick in customer traffic in the merchant location, or in sales, or some other indication of the success of running a customer loyalty rewards program enhanced rewards distribution campaign that would require more financial commitment on behalf of the merchant. Then a second level merchant commitment campaign, which by way of example may be denoted “basic II”, can be selected, and which, by way of example, and for simplicity in explanation, doubles the cost to the merchant, or at least doubles the outlay of rewards, if one considers that the outlay of the merchant in the first noted campaign level simply equaled the cost of the normal individual rewards given out to all customers (assuming each individual would have redeemed such normal individual reward) and assuming only the 100 customers of the example. Thus, the merchant may agree to give out 20 enhanced rewards, e.g., still at a rate of one in 10, and thus, theoretically at least, still at no increased cost to the merchant in terms of the dollar value of enhanced awards granted as against dollar value of normal rewards granted. Assuming that not all of the recipients of the normal check-in reward would convert the check-in reward discount coupon, the cost to the merchant slightly exceeds the distribution of the normal rewards to all users who check-in as opposed to the twenty enhanced ten dollar rewards. Thus a results array with 200 entries could be established by the RDS, with 20 entries indicating the participant received the enhanced reward and the remainder not resulting in an enhanced $10 reward for the participant.

It will be understood that other forms of being “checked-in” other than a “location-based check-in” may for a criteria for a means of entry to being provided participation events as a user/participant. The further notifications, e.g., from “checking-in” in the social network context may or may not be a requirement also. The RDS, in essence acting as a merchant as discussed in the present application and/or another merchant, may engage in so-called “white-label” advertising to promote the used of the RDS system for loyalty rewards enhanced rewards distribution generally or for the RDS in particular, to promote in some cases, just the RDS or the RDS and to a more minor degree than discussed elsewhere in the present application, the merchant. As noted, also “checking-in,” perhaps with the link to the social network, but not necessarily so, can occur when the user/participant performs some act the merchant is promoting, such as the bank acknowledging that the user/participant is signing up for on-line checking and promoting that fact to others through the enhanced reward distribution system and method as discussed here. By extension this can include the RDS system, with or without other merchant participation, promoting the adoption of loyalty program random enhanced reward distribution services for itself.

In addition to recognition of benefit to the merchant from going from the first level of merchant commitment to the second level as noted above in row 230, the merchant may see benefit in an enhanced participant, e.g., with more than the one basic means of entry. Thus the merchant may agree to upgrade the classification of the participant to level 2, if the participant in addition causes a “liked” indication to be broadcast to the participant's social network friends. Or perhaps, the merchant would like the participant to submit a user/consumer profile, containing some or al of the information noted above to be potentially within such a profile, and agree to accept focused advertising, coupon offers, etc. from the merchant, which the merchant values. As another example, the merchant, e.g., a bank, may want to encourage the user/participant to engage in some other activity beneficial to the merchant, such as sign up for on-line banking or on-line direct bill paying, etc. In such an event, the merchant may agree to also double the total award for this level of participant “value.” Thus the same “basic level II” campaign as for the second position in row 230/first position in column 212 is provided for the level 2 participants (second position in column 210, first position in row 232) as is provided the level 1 participants in the first position in column 212. These are denoted campaign level 2 in FIG. 5

As another example, the merchant may decide to again up the ante for a participant in level three, first position in row 234, e.g., who has both submitted a “liked” indication and agrees to submit the user profile and accept advertisements, or has one or more other means of entry criteria found desirable to the merchant to substitute for one or both of the “liked” criteria and/or the profile criteria, or performing some other act the merchant finds desirable. In such an event, a third level campaign may be established which again, as an example only, doubles the cost to the merchant over the previous level 2 campaign, such as the merchant agrees to give out twenty enhanced rewards of $20 each. Again the results array with two hundred entries including twenty entries indicating the reward of $20 for that participation event of the respective participant and the remainder indicating no reward, can be utilized by the RDS as noted above.

It will be understood that this same third level campaign may be offered as the next level up in the merchant's commitment in row 230, i.e., in the first position in column 214 and the third position in row 230, should the merchant see the need to go to the third level of merchant campaign above the commitment for the basic participants. This could be, by way of example, denoted a “Regular” campaign for the merchant participation level of column 214 for a “basic level I” participant (the first position in row 230 in column 214). It will also be understood that under this example of a loyalty program enhanced reward distribution matrix 200 the merchant may provide the same level three merchant commitment campaign to the level two participants, i.e., the second position in column 212 and second position in row 232. Thus a level three campaign for each of those positions is created as indicated in the campaign matrix 200 FIG. 6. This process can continue to fill out the campaigns for a level 4, a level 5, a level 6, a level 7 and a level 8 of both increasing merchant commitments across row 230 and of increasing participant advertising “value” down column 210 and in the remaining positions in the matrix 200, as shown in FIG. 6 and may continue to further expand the matrix 200 as indicated by the ellipses in FIG. 6.

At some level of merchant loyalty reward program enhanced reward distribution campaign commitment, the merchant may decide to partner with or even seek a full reward provider/sponsor. As an example, assuming the average participant has fifty “friends” on the social network, the merchant may agree to upgrade the participant value level to a fourth level for participants with at least 100 friends, seeing the additional advertisement value in the added number of friends, e.g., with this as a means of entry requirement for participant “value” level 4 (the position at the intersection of row 336 and 210). In this case, the merchant may also see the value in upping the reward to, e.g., a pair of Nike® running shoes worth, e.g., $100, and give out 10 rewards of this kind per day at a rate of one participant in ten for the level 4 participant, and as explained by example above, e.g., for a “gold” level of merchant commitment for this enhanced reward at the level of column 216 in row 230. Nike may also see the advertising value in participating in the merchant's customer loyalty rewards program “gold” enhanced reward distribution campaign and subsidize some part or all of the cost of the pairs of shoes constituting the rewards. Again, a results array with one hundred entries can be created by the RDS with ten entries indicating the award of the enhanced reward of the pair of shoes and the remainder indicating no award. Once again, the merchant may decide to provide this same campaign for the positions in the first position in row 236, the second position in row 234 the third position in row 232 and the fourth position in row 230. Thus a “gold” level 4 campaign is created for those positions in the campaign matrix 200 as indicated in FIG. 6. It will also be understood that the merchant may elect to set up or select a campaign from the matrix that is available to participants who meet the defined means of entry but are not geographically co-located or even using the same media to access the RDS server and thus the game and the results array. As an example, a campaign may be accessible by all who have indicated that they “liked” the merchant, without also requiring a physical location “check-in.” That is, the “check-in” could be entry into the game and be made using a mobile device, from whatever location, or the participant/users desktop or deskside computer, or lap top on a plane, etc. Another example, could be that the merchant defines or selects from the matrix a campaign where the means of entry, without more, is the user/participant has physically location “checked-in” or has at least two hundred social network “friends.” Again, the same game and results array on the RDS server can then be accessed by mobile devices of participant/users who are at the merchant location because they have physically location “checked-in” and other user/participants who have simply “checked-in” to the game, e.g., from a home computer.

The merchant at the point of introducing a partner, e.g., in the manner just noted, may solicit partners according to the dollar value of the enhanced reward sponsored, the percentage amount of the sponsorship by reward provider, the brand recognition of the reward itself, or other criteria. The merchant and/or the RDS operator may charge the reward provider a fee for participation in the customer loyalty rewards program random enhanced reward distribution campaign involving the provided enhanced reward. In this fashion the merchant may be able to continue to increase the levels of campaign commitment, and or participant value level differentiation to fill out the matrix. Merchant level of commitment to the campaign across row 230 may simply be the continuing recognition of the return on investment by administering customer loyalty reward program enhanced reward distribution campaigns of higher and higher cost to the merchant, in total reward cost to the merchant of a given campaign, in either or both of reward cost increases and increases of the number of participants being granted the reward. Similarly increases in user/participant advertisement value can continue to be judged to call for a higher level of merchant participation commitment, and thus reward value and/or number distributed being increased from level to level. Generally the matrix is populated by campaigns that cost more to the merchant or merchant and partner moving down and to the right in the matrix 200, and are thus more attractive to users/participants as well.

The above is just an example and many variants are possible, including up to all or most of the positions in the matrix 200 being occupied by uniquely different customer loyalty program enhanced rewards distribution campaigns. As noted above the possibilities for differences in the individual campaigns are also widely varied, and more than just in the total cost of the campaign to the merchant or merchant and partner, sponsor, etc. may be involved. The representation of the games can vary in type, complexity and opportunity to be a recipient of an enhanced reward, enhancing user/participant interest. Multiple games can be offered and/or multiple successful game outcomes. The games can have factors that cannot be pre-defined, outcome-wise, as A recipients in B participation events, etc., most of which variations are discussed or suggested above. As the represented games become more in number, more complex, have more possible positive game outcomes, result in higher value rewards and/or higher probabilities of a participation event resulting in an enhanced reward, allow for more free plays, etc. the user/participant motivation to engage in the customer loyalty rewards program random enhanced reward distribution campaigns increases, the advertising value to the merchant increases, the overall popularity of such systems and methods increases and the merchants, users/participants, RDS operator, etc. all benefit. Many participants can benefit, including the RDS, the social networks, consumer purchase account issuers and transaction handlers, communication connection providers and perhaps even other entities involved in the promotion, operation and management of such a customer loyalty rewards program random enhanced rewards distribution system and method, such as reward sponsors. Parties involved in the selection and distribution of targeted and focused advertising, offers and the like, the identification of the targets of such advertising, e.g., based on relation to or connection to a user participant and the like entities may also produce revenue from such participation, as will be well understood by those in the art. Many or all of these functionalities, and thus also financial benefits may be accrued to the operator of the RDS server(s) and related servers.

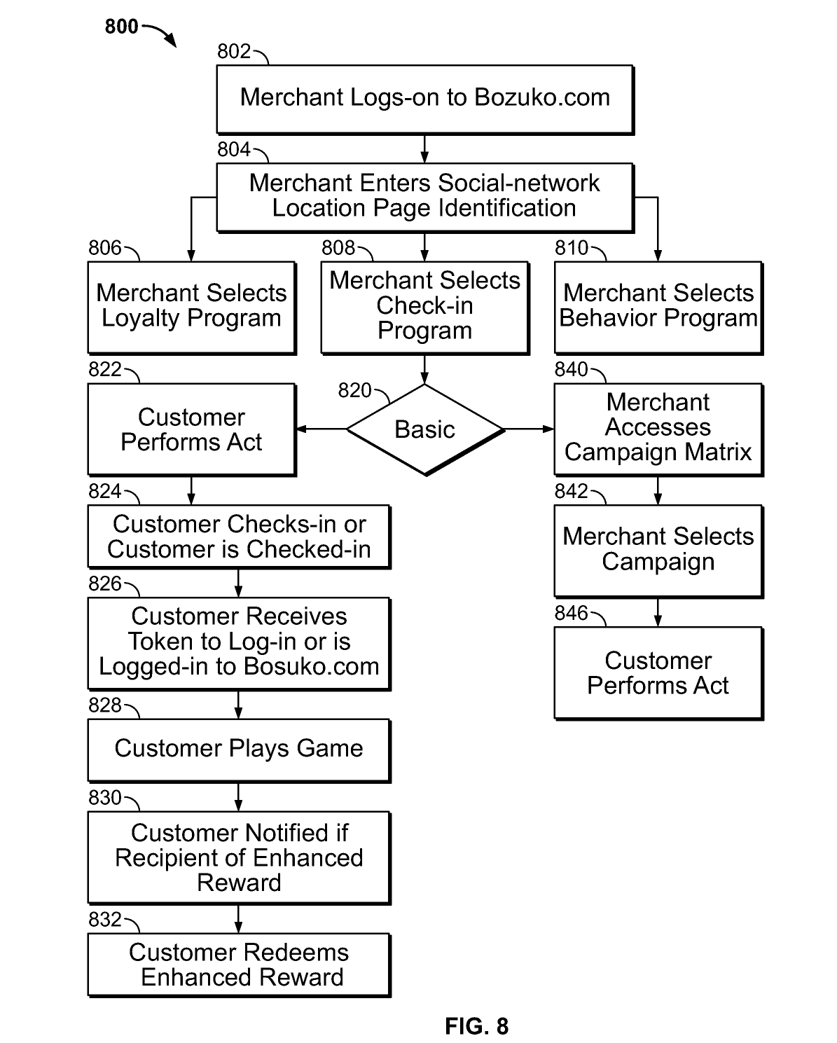

FIG. 7 shows a block diagram form of a system 300 according to aspects of embodiments of the above discussed systems and methods. The system 300 may include a customer loyalty rewards program random enhanced rewards distribution system 302. The system 302 may include a customer loyalty rewards program random enhanced reward distribution system (“RDS”) server 304. The RDS server may include a server operator user interface 306 to the server 304, such as a PC. The server 304 may also be connected to one or more databases, such as, by way of example, a random enhanced reward distribution campaign database 310, an internet service provider/social network service/email/search engine provider database 312 and a transaction handler database 314, it being understood that these databases could be combined, supplemented, organized in different ways as content, functionality, etc. The system 302 may also have a gateway 320 connecting the system 320 to other systems noted in FIG. 7 and the Internet 290. The server 204 may operate and/or work in conjunction with the RDS core application (not shown in FIG. 7)

A connections provider system 330 may include a connections provider server 332 and a database 334 which may store targeted advertisements. The targeted advertisements may be distributed by the connection provider 330 in a variety of ways well known in the art, including through knowledge of the user of a user device, such as a portable user device 350, the location of the user/user device 350, etc. The advertisement distribution may be on behalf of advertisers, such as participants in bidding for pay for performance advertising over the communication network and/or subscribers to on-line directories of users of the communication network of the connection provider 330. The telecommunications connection provider 330 can also include a gateway 336.

A consumer credit payment system 360 may represent a consumer payment device issuer such as American Express Card® or Discover Card® or transaction handler such as Visa® or MasterCard® processing authorizations and settlements of consumer credit transactions on behalf of other issuers, such as banks or financial institutions. The transaction handler system 360 may have a server 362 and a plurality of databases, such as a transaction database 364, which may include, e.g., records of the transactions and the like generated by a transaction handler from processing transactions of users. Such transactions may be made via credit accounts, debit accounts, prepaid accounts, bank accounts, stored value accounts and recorded in the database 362 for settlement and financial recordkeeping, which can, e.g., provide information for various services, such as reporting, benchmarking, advertising, advertising content or offer selection, customization, personalization, prioritization, etc. Transaction data can include transaction amounts, the identities of the payees (e.g., merchants), which can be correlated to the businesses, services, products and/or locations of the payees, and the date and time of the transactions.

The transaction handler can maintain in the database 364 merchant data, including the merchant locations, businesses, services, products, etc. Thus, the transaction data can be used to determine the purchase behavior, pattern, preference, tendency, frequency, trend, budget and/or propensity of the customers in relation to various types of businesses, services and/or products and in relation to time. Products and/or services purchased by the credit card user can also be identified by the information transmitted from the merchants or service providers, e.g., identification of the individual products and/or services, allowing for generation of transaction profiles with fine granularity or resolution, e.g., at a level of distinct products and services that can be purchased (e.g., stock-keeping unit (SKU) level), or category or type of products or services, or brand or vendor of products or services, etc. Transaction data thus can include information on purchases made by various users at various times via different purchases options (e.g., online purchase, offline purchase from a retail store, mail order, order via phone, etc.). All of this information may be used in the system and methods of the disclosed subject matter, e.g., to select and publish targeted focused and effective real time advertizing to users and others involved in the activities noted above respecting customer loyalty rewards program random enhanced rewards distribution systems and methods discussed above, to enhance advertising value level of a participant and/or the merchant's level of commitment for the campaign matrix 200, to tie to other customer loyalty programs in which the participant is enrolled, etc.

Also included may be a data warehouse database 368 which data warehouse may include data storage coupled with the transaction handler information regarding, e.g., transaction data and other data, such as account data, transaction profiles and correlation results and may be organized around the transaction data, e.g., including, and/or supporting the determination of spend band distribution, transaction count and amount, merchant categories, merchant by state, cardholder segmentation by velocity scores, and spending within merchant target, competitive set and cross-section, in order to help manage advertisement campaigns and the like and analyze response profitability. Such a data warehouse 368 can include merchant data (e.g., data about sellers), customer/business data (e.g., data about buyers), and transaction records between sellers and buyers over time. The data warehouse 368 can be used to support corporate sales forecasting, fraud analysis reporting, sales/customer relationship management (CRM), business intelligence, credit risk prediction and analysis, advanced authorization reporting, merchant benchmarking, business intelligence for small business, rewards, etc. The information may also assist the merchant and/or the RDS in establishing and managing and evaluating customer loyalty rewards programs random enhanced reward distribution systems, such as are run on the RDS server 304 and related server(s) (not shown).

The consumer credit payment system 360 may also include a user interface 380 and a gateway 382. The system 300 also includes a merchant system 390 which can include a merchant server 392, a point-of-sale or other customer/merchant/transaction handler interface device 396, a merchant database 394 and a gateway 398. The system may also include a social network 400 accessed through the internet 290.

Each of the systems 302, 330, 360, 390 and 400 can be interconnected to take advantage of information available through the social network 400, customer profiles and contact information from the social network 400 or from the participant, or from transaction data available from the merchant or consumer payment system 360 utilized by the merchant or by the participant, the location of the participant communication interface 350 and other information available from the participant's communication interface, such as the mobile device 350, and from the connection provider 330 for the participant's mobile communication interface device 350, all of which information can be used to help determine the participant advertising value to the merchant, to select and broadcast targeted focused advertisements to the participant and others, such as the social network 400 and other contacts involved in some way in the conduct of loyalty reward program enhanced reward random distribution campaigns on the customer loyalty rewards program random enhanced reward distribution system 300.

Any one or more of the systems 330, 360, 390 and 400, in addition to the random enhanced reward distribution system 302, may be in communication with the user/participant through the user's/participant's communication interface device 350, such as the mobile device 350, either directly, through the connection provider system 330, through the Internet 290, including through the social network 400 operating on the Internet, and the like, as well as with other parties taking part in any way in the loyalty rewards program random enhanced reward distribution system, such as receiving notice of events occurring in the random enhanced reward distribution system regarding participants, participation events, participation event results, enhanced reward redemption and the like, and/or including selection, distribution and receipt of targeted and focused advertisements, coupons, offers and the like from the merchant, the social network, the pertinent transaction handler, the pertinent connection provider or the random enhanced reward distribution system (“RDS”) operator, etc. As noted above, any or all of these functionalities and utilizations of information and the like may be accrued to the operator of the RDS server(s) 304 and other associated server(s).

The following is an example of one possible implementation of the disclosed subject matter in further detail, by way of example only. A merchant decides to implement a customer loyalty rewards program random enhanced reward distribution program campaign examples of which are discussed. above and herein designated as a “Bozuko™ game” for the merchant, e.g., a merchant location of the merchant. The merchant, e.g., through a campaign account manager can log-on to Bozuko.com™ and concurrently log in to use the merchant's social network account, such as, a Facebook account, and in particular a Facebook Merchant Page, which can also have a Facebook Merchant Location (Place) Page. The merchant account manager selects the Facebook Place (of the merchant to associate with the merchant's Bozuko game enhanced reward distribution campaign. At the same time, the Bozuko server 304, e.g., using the core application may access other standard online account information (contact information, etc.) concerning the merchant, if not already possessed in the Bozuko server 304.

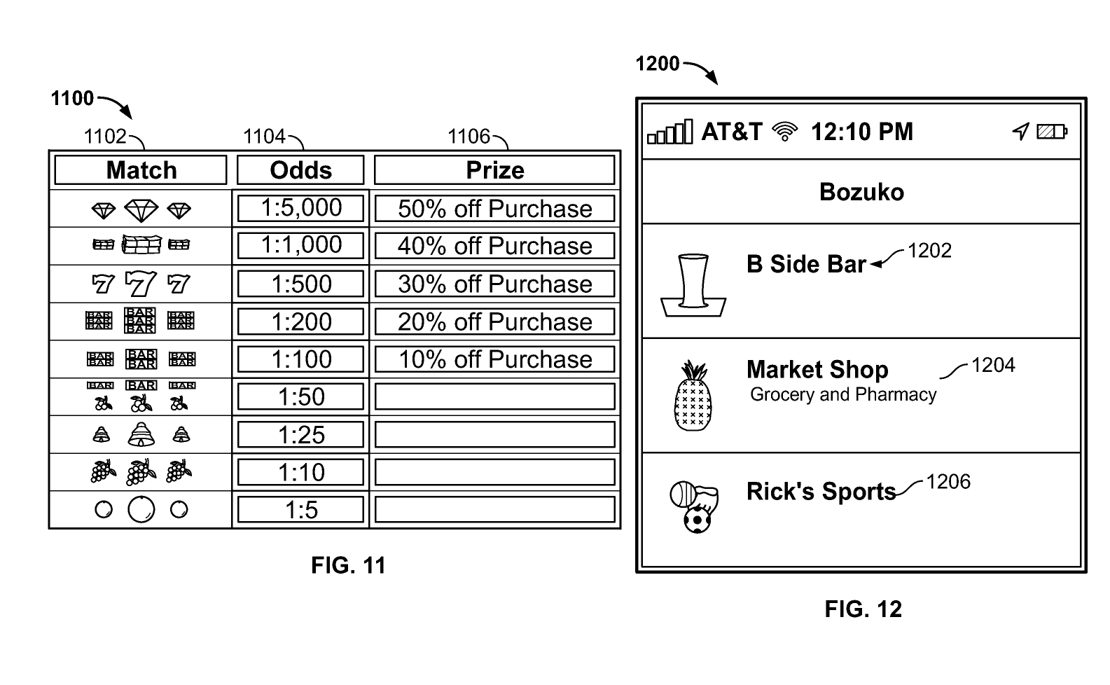

The merchant then selects the game type(s) the merchant would like to implement as part of the campaign. Choices may include Slots, Dice, Scratch ticket, etc. Each game will have an associated “information” button which describes in detail how each can be used. Game selection can affect the amount and mechanism of enhanced rewards being distributed. Prize selection is also related to game type. In the example of a Slot Machine game prize selection merchant campaign manager user interface 1100, such results illustrated, by way of example, in FIG. 11, can include the odds 1104, which can be displayed for a participation event result 1102 resulting in a specified enhanced reward 1106, such as three diamonds for 50% off a purchase, or $50.00 off of a purchase (not shown in FIG. 11), the latter of which may also be a cap on the percentage-off coupon award. The merchant enters rewards 106 based on the suggested odds 1104 of outcome, such as, 1:5000.

The merchant may alter the suggested odds 1104 of individual outcomes (e.g. make 3 diamonds 1/1000 odds not 1/5000), and appropriately modify the lesser enhanced reward odds ‘1104 as well. The odds 1104 make more expensive prizes more rare and cheaper prizes more frequent. The merchant may select all the available combinations or leave some blank, such as the more frequent lower value enhanced rewards, as illustrated in FIG. 11 and these can be eliminated from possible outcomes displayed to the user. Alternatively the lower ranking odds may be applied to, by way of example, one free play (1:5), two free plays (1:10), three free plays (1:25) and four free plays (1:50), and like non-prize awards. It will be understood that the free plays and/or other forms of non-prize awards could also be interleaved among the actual prize awards, with odds assigned according. It will also be understood that, for purposes of simplifying the selection and setting up of a campaign, e.g., by the merchant account manager, a chart, as shown by way of example in FIG. 11 may be used to define a campaign. As an example, the merchant what wants to select a level 4 campaign, however denominated for marketing purposes, such as for the positions marked 4 as illustrated in the example of a campaign matrix 200 shown in FIG. 6 (also perhaps including the free play “awards” as discussed above) may be presented with a user interface display as shown in FIG. 11. The display can, therefore, define the “game,” the awards and how often they will be distributed according to an associated results array (FIG. 1 or 2), and, therefore, in most cases, an indication of a total cost to the merchant, or at least a cap. Some measure of the advertising “value” to the merchant may be indicated, such as cost per check-in, cost per full prize cycle notifications (post check-in), cost per “friend” notified, cost per advertisement delivered to the participant, cost per advertisement delivered to “friends,” etc. This may be based solely on the prizes to be awarded, and added costs, such as the RDS service provider fee(s) may also be presented.

The merchant, in addition, may make other selections (not shown) on the reward distribution system (“RDS”) server 304 in the core application, such as, the time for which the game will be available, the total quantity available of each enhanced reward and related options. A game may be shut down when any single prize has been distributed, or may continue to run after a prize quantity is gone, with that prize eliminated as a possible outcome. The merchant also selects the number of plays per user per participation event, e.g., resulting from a single check-in. The merchant can select the number of means of entry, such as check-ins the user must complete to be entitled to a participation event. Once a location requirement is configured, the merchant may choose to allow off site use (no physical location “check in”) for a given campaign. The on site requirement (check-in) may be confirmed using GPS or a wifi signal of in-store tracking systems, or the like. The merchant selects the frequency of play for a given user, e.g., so the merchant can review results of the campaign that are not skewed by a single or a few users accounting for all or most of the participation events in the particular campaign. This could be once an hour, once a day, etc. The merchant selects the time for redeeming a enhanced reward, the time the participant has to redeem the enhanced reward before it expires. The easier it is to redeem the enhanced reward, i.e., in person, online, etc. the shorter the time to redeem.

Turning now to FIG. 8 there is shown, by way of example, a process 800 flow for implementing an example of a loyalty program enhanced reward distribution system and method according to the disclosed subject matter in the present application. In the step indicated in block 802 a merchant logs on to an enhanced reward distribution system (“RDS”) service server, e.g., run by Bozuko, Inc.™, such as Bozuko.com. In block 804, the merchant may enter a social-network location page identification for a location of the merchant, such as a Facebook® location Page, but which could also be a social network “location page” linked with a merchant but not a location, e.g., a web-p[age, or simply a web-page without a specific tie to a merchant. In blocks 806, 808 and 810, as examples, the merchant may select one or more of a loyalty program, a location check-in program and a behavior program (e.g., where the merchant encourages certain activity of the user, e.g., a bank encourages signing up for direct deposit, or automatic on-line bill paying or an ATM card, by “checking-in” the customer actually doing so, just like the case of a location “check-in”). Assuming the selection is of a location “check-in” program and the merchant has only set up a campaign account with one form of “basic” check-in customer loyalty program random enhanced reward distribution, the process moves from decision block 820 on to block 822, where the customer/user performs an act and thereby “checks-in,” e.g., by performing a social network location check-in on a social network merchant location page for a given merchant, or agrees to perform an act that the merchant and/or the RDS find beneficial and/or from which the RDS and/or merchant can derive some form of advertising benefit/value to the RDS and/or merchant.

In the case illustrated, the act is a location check-in in block 824, e.g., with a social network like Facebook at the merchant's location, e.g., using the Facebook Location Page of the merchant. In other instances the act could be, e.g., signing up for a loyalty program, upgrading a credit card, signing up for on-line bill paying, or the like. The customer in some cases may be automatically checked-in, e.g., when placing a call from the merchant's location or making a purchase with a credit card at the merchant's location, or the customer may at least be prompted by the connection provider for the mobile communication device of the customer or by the transaction handler for transaction approval for the particular credit card, or the like, to actually perform the check-in. The customer may then receive an indication that the customer has qualified for a check-in loyalty program reward, such as a $1.00 off coupon, by actually receiving the coupon on the participant/user's mobile communication device or the like or by automatically being logged in by the merchant, the social network or the RDS service operator, such as Bozuko, Inc.™, to the loyalty program enhanced reward random distribution system server 304 and presented with the representation of the game of chance according to the particular campaign being implemented by the RDS server 304 for the merchant and the participant/user's means of entry requirements that happen to be satisfied by this particular customer. The customer plays the game as indicated in block 828, is notified if the distribution system selected the user as a recipient of an available reward in block 830 and redeems the reward, if that is the case, in block 832, all as described in more detail on the present application. The merchant could also select other RDS campaigns from the campaign selection matrix (200 in FIG. 6) or custom design a campaign, in blocks 840 and 842, in which even the customer performing an act in block 846 associated with a particular selected campaign leads back to blocks 824, 826, 828, 830 and 832.

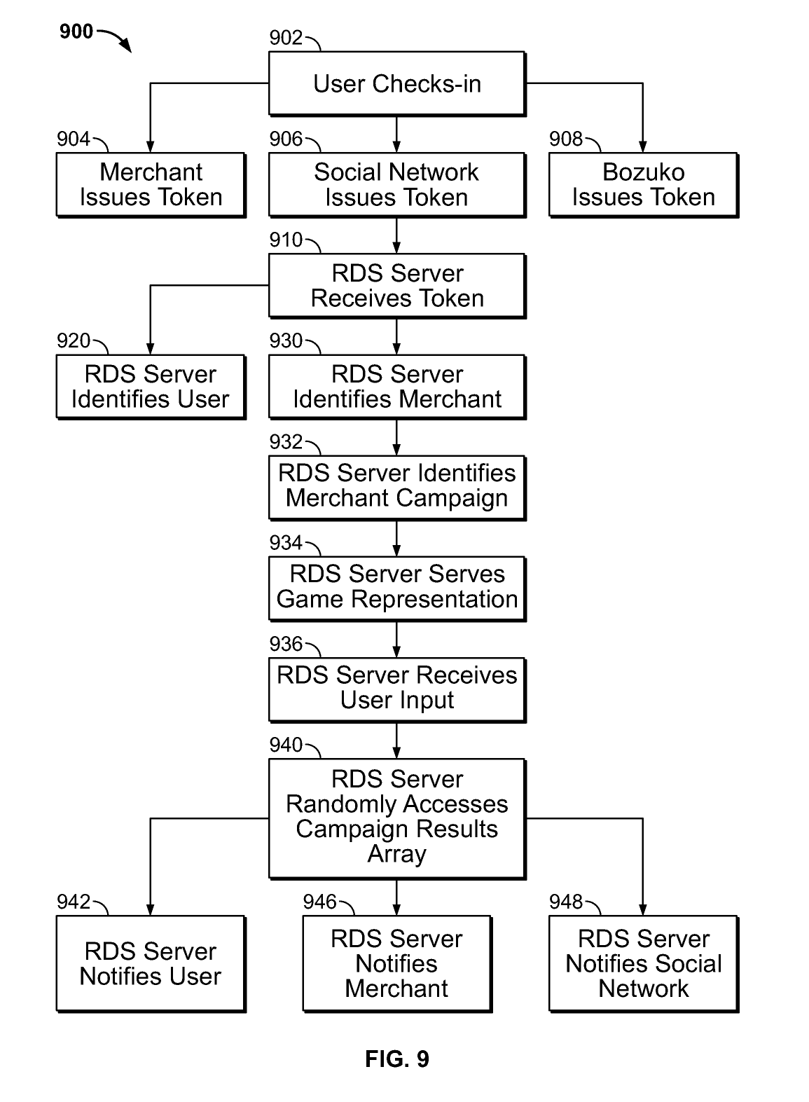

Turning to FIG. 9, there is shown a process flow 900 for a user/participant to participate in a loyalty program enhanced reward RDS according to aspects of the disclosed subject matter. In block 902 the user/participant checks-in, again as part of a “location check-in” or some other form of “check-in” such as to encourage customers to behave in a selected manner, like sign up for on-line checking. In blocks 904, 906 and 908, respectively, the merchant, social network or the RDS service operator issues the customer a check-in rewards program check-in token, indicating the customer has qualified for the un-enhanced check-in reward, such as a $1.00 off coupon. The coupon could be directly forwarded to the RDS service server 304 in block 910 or so directed by the user/participant who receives the token. The RDS server 304 can then identify the user/participant and the merchant in blocks 920 and 930 and the merchant campaign in block 932. The RDS server 304 can then serve a representation of a game of chance in block 934 and receive appropriate response(s) from the user/participant in block 936 after which the server 304 accesses the campaign results array, e.g., randomly so accessing, in block 940. The un-enhanced check-in reward token acts as an indication there was a “check-in” assuming that is a required means of entry for the particular campaign. The server may then notify the user participant, the merchant and the social network of the results of this particular participation event. The social network, the RDS server 204 and/or the merchant may take steps to notify others in the social network, e.g., “friends” and “friends of friends” of the user/participant out to some selected degree of connectivity, of the events, such as the check-in, the subsequent game service and the results, including the prize won, where applicable, etc.

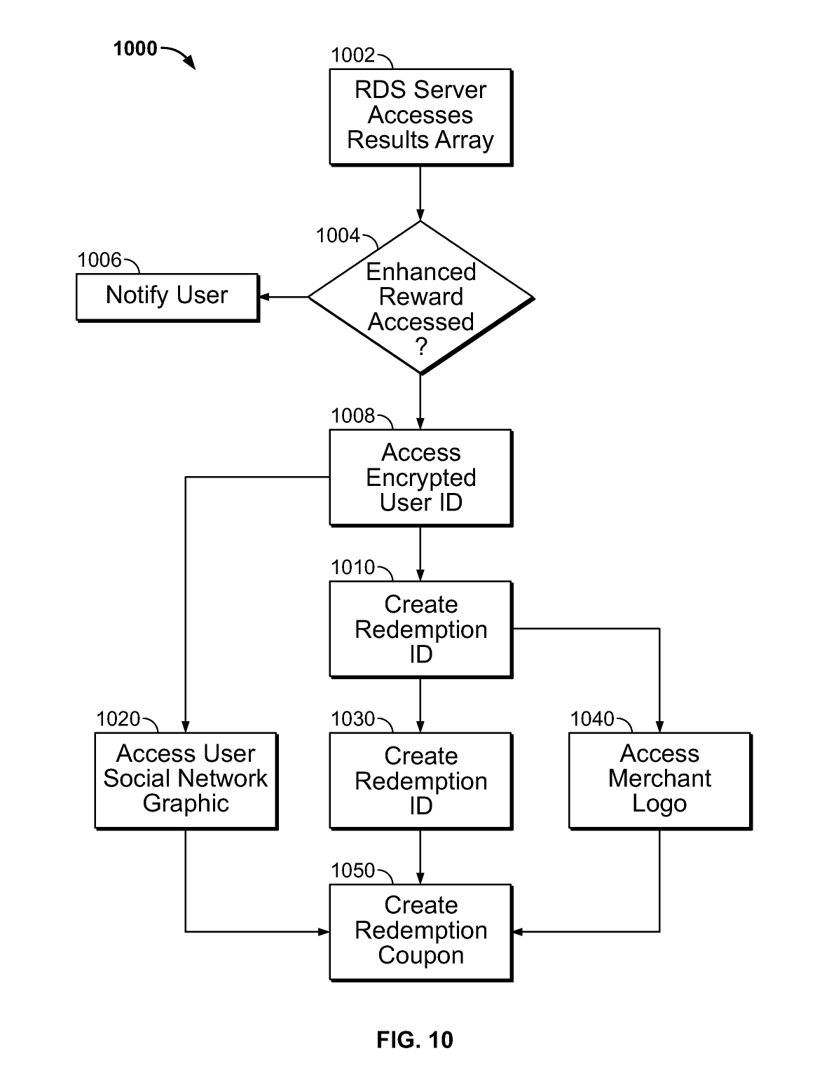

Turning now to FIG. 10 there is illustrated by way of example a process flow 1000 for enhancing security in a customer loyalty enhanced reward random distribution system. In block 1002, the RDS server 304 accesses the selected enhanced reward random distribution system results array and if there is no reward in the accessed array space(s) as determined in decision block 1004, so notifies the user participant in block 1006. When an award is indicated, the server 304 can access the server database and retrieve an encrypted user/participant ID stored in the database for the particular user/participant. This can be an encrypted ID that is created by the RDS when the user/participant first enrolls with the RDS or a user ID is received by the RDS identifying the user from, e.g., the merchant or the social network. The RDS may then in block 1020 access a social network or other graphic associated with the winning user/participant. The RDS may then access/create an encrypted enhanced reward redemption ID in block 1010. The redemption ID may have already been created, e.g., identified with a particular campaign and particular prize, when stored in the results array, and may have been encrypted at that point, or may be encrypted in block 1010 by the system process 1000. The RDS server 304 may then access a merchant logo in block 1040 and create an encrypted merchant ID for the particular reward in the particular campaign. These may then be utilized as a basis for inputting the information to a redemption notification, such as is shown in FIG. 3a-d or 18a-d, discussed above. In this way, as an example, the RDS can secure the redemption process, such that even with information about the reward program campaign and the merchant and the reward in a decrypted format (decrypted by the RDS for that purpose), only the RDS server can retranslate the responses from the user/participant back to the correct internal identifications of these features of the redemption system that are stored in encrypted form within in RDS server.

A user can download the Bozuko application to the user's mobile device, and can see the Bozuko game random enhanced reward distribution system campaign(s) available and where the campaign(s) is focused, e.g., as shown in FIG. 12., such as a campaign 1202 for the B Side Bar, the Market Shop 1204 and Rick's Sport's 1206. When launching the Bozuko application, the physical location of the user is determined, e.g., in the Market Shop grocery store. In some cases, e.g., since GPS is not perfect, the Bozuko application may be populated with available Bozuko Places in the area. Alternatively even for precise user location, the application may display other merchants in the vicinity with available Bozuko campaigns, i.e., all of the available campaigns geographically close to the user at the moment, e.g., as noted in FIG. 12, the Market shop and/or Rick's Sports may be in the vicinity of the B Side Bar. It will also be understood that, after a user has checked-in at, e.g., the B Side Bar, redemption of an award from a B side Bar campaign can be verification that the user was actually in the B Side bar when checking-in. Other aspects of the loyalty program enhanced reward distribution system and method of the present application may be used to verify an actual check-in at a merchant location. As an example, the notification by the RDS server of the merchant that a check-in at the merchant location has triggered the presentation of a enhanced reward distribution opportunity to a participant, assertedly in the merchant location, can move the merchant to take steps to verify this, e.g., with assistance from or access to a connection provider's database, or with assistance from or access to a transaction handler database, by mobile phone location triangulation or in-store monitors, or the like, etc.

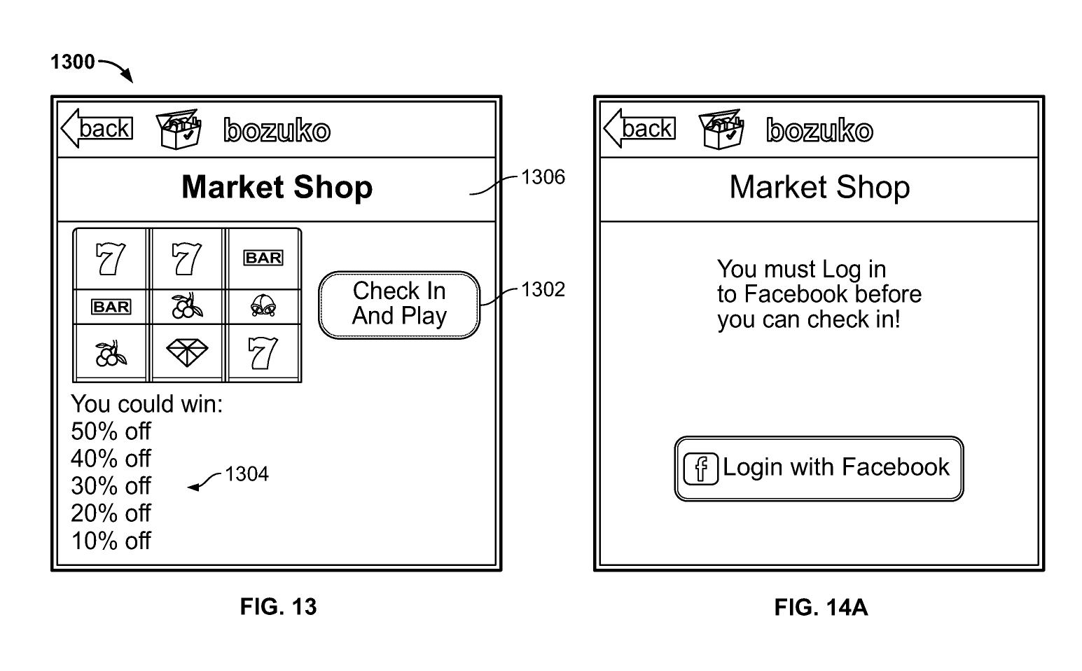

In any event, the Bozuko core application running on the RDS server 304 may populate the Bozuko Place List. Inputs include GPS coordinates received from the Bozuko mobile application, GPS coordinates received from the Facebook API, or a registered location of the Facebook Place. Facebook can send back close by Facebook Places or the RDS can search for nearby places with active campaigns. The Bozuko core application can check to see which of the Facebook places or other nearby places have an active Bozuko game, which can be sent to the user mobile application device 350. The user selects a campaign from the screen of FIG. 12, such as the Market Shop campaign. A Play Screen 1300 for the Market Shop merchant 1306 campaign, as shown in FIG. 13 is displayed on the user's mobile device 350. The play (participation event) screen 1300 indicates to the user where the user is (for confirmation), and what are some or all of the available prizes. The Play screen 1300 of FIG. 13 gives the user an option 1302 to “Check In And Play” or return to back Places. It will be understood that the user may arrive at the play screen 1300 of FIG. 13 in other ways, such as having checked-in at the Market Shop on the Market Shop's Facebook Place page initially, or other ways noted herein. Bozuko, e.g., through the RDS server 304, can populate the Play Screen 1300 in FIG. 13, by receiving a designation of the place selected by the user of the core application. The core application accesses information stored at the RDS or obtained information from elsewhere and then stored at the RDS, such as from Facebook, the merchant, or others, and identifies available campaigns 1304 for the merchant/location 1306. The game type and enhanced reward list 1100, as shown in FIG. 11, can also be sent back to mobile user application 350.

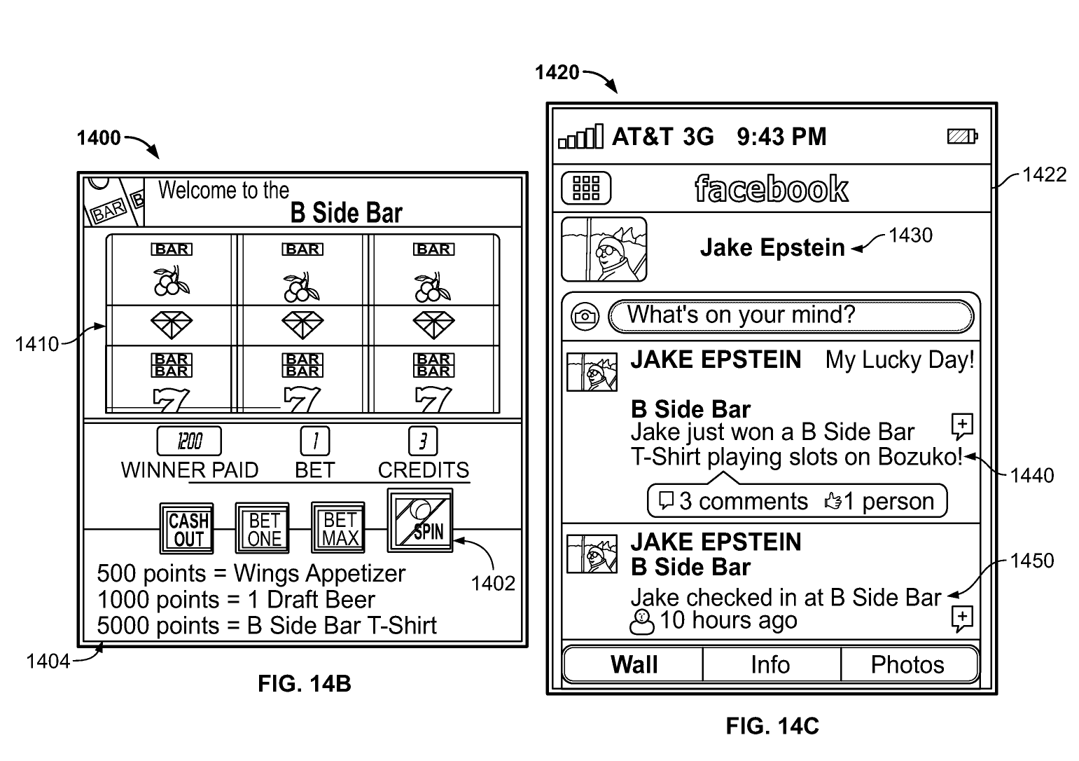

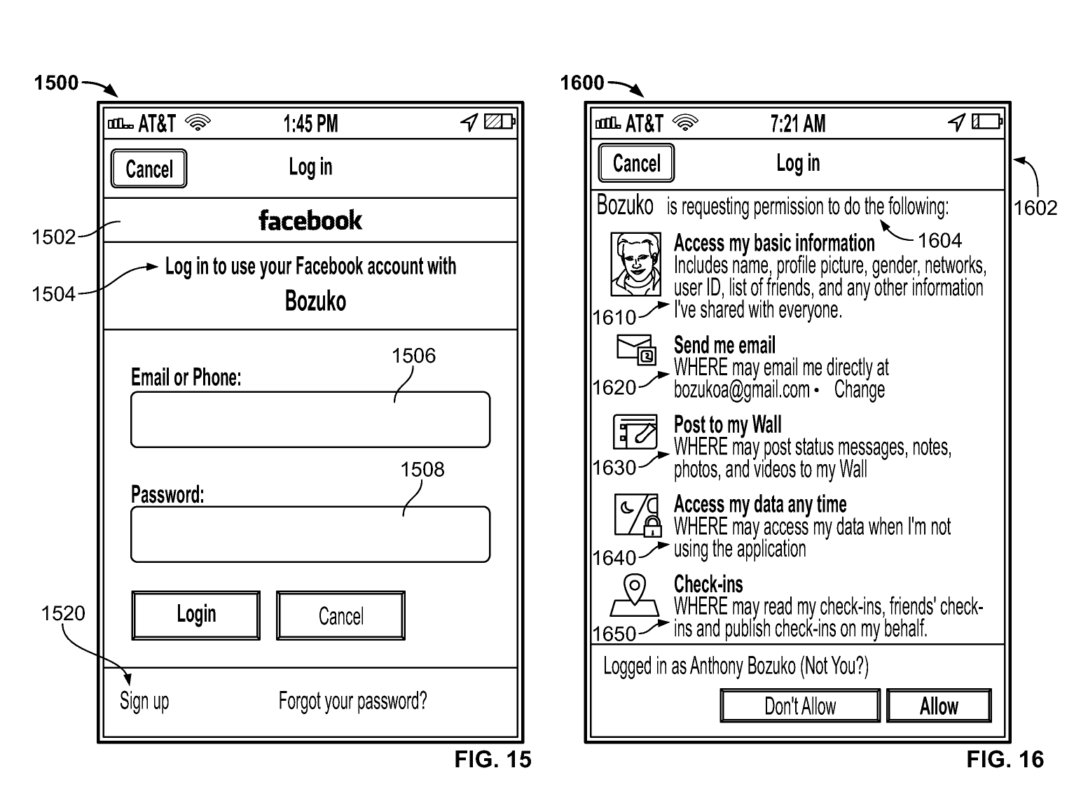

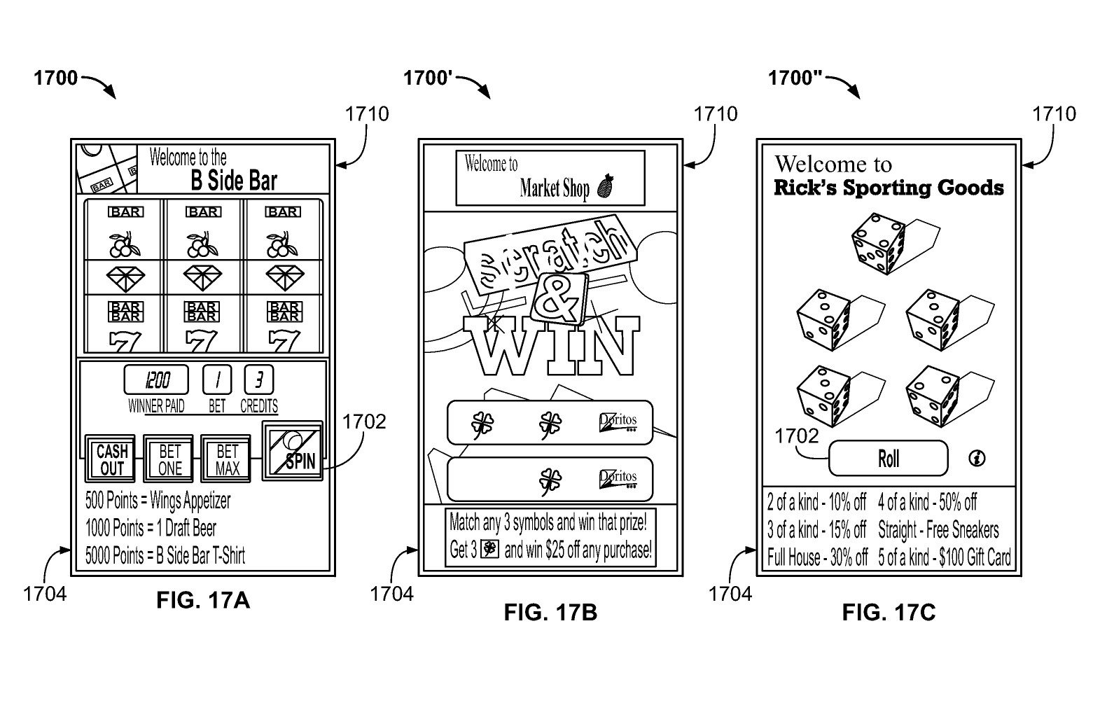

The user may then select “Check In And Play” 1302 on the campaign screen 1300 of FIG. 13. The user may not yet have associated the user application with a Facebook account for the merchant, Market Shop 1306. The user may be asked to sign in to Facebook, such as is shown by way of example in FIGS. 14a-c, 15 and 16, and once there, to agree to terms of use—including allowing check-ins (as an example from the Facebook application “Where”). The user graphical user interface of FIG. 14a prompts the user to log-in to the user's Facebook account with Bozuko, i.e., either residing on the Bozuko RDS server 304 or accessing the account through the Bozuko RDS server. The RDS, Bozuko, can then return the user to the Play Screen 1300 of FIG. 13. The user selects “Check In And Play” 1302 again and then is transitioned to the Game screen, such as one of 1400 in FIG. 14b and 1700 in FIGS. 17a-c, by way of examples. This process can result ion the RDS retaining enough information about the user so as to go directly to the game play screen(s), 1400, 1700, such as are illustrated by way of example in FIG. 14a and FIGS. 17a-c for a given campaign, except perhaps in some cases if the user has logged off of Facebook. Once logged into the game screen, FIG. 14a and FIGS. 17a-c, the Bozuko core application can send game details to the user mobile application. As an example, the user may be informed, using, as an example, the display 1100 in FIG. 11, that a certain game outcome results in a certain enhanced reward, such as, 3-diamonds=50% off or $50.00 off. The user may be informed of the enhanced rewards available for each game outcome 1106, the odds 1104, 1704, and the number of plays available. These can also be seen in the display, as an example, shown in FIG. 17b. The user activates the game, i.e., clicks on a “spin,” “roll,” “scratch” button 1402, 1702 or the like and sees the game outcome 1410 and whether it results in the distribution of an available enhanced reward or not.

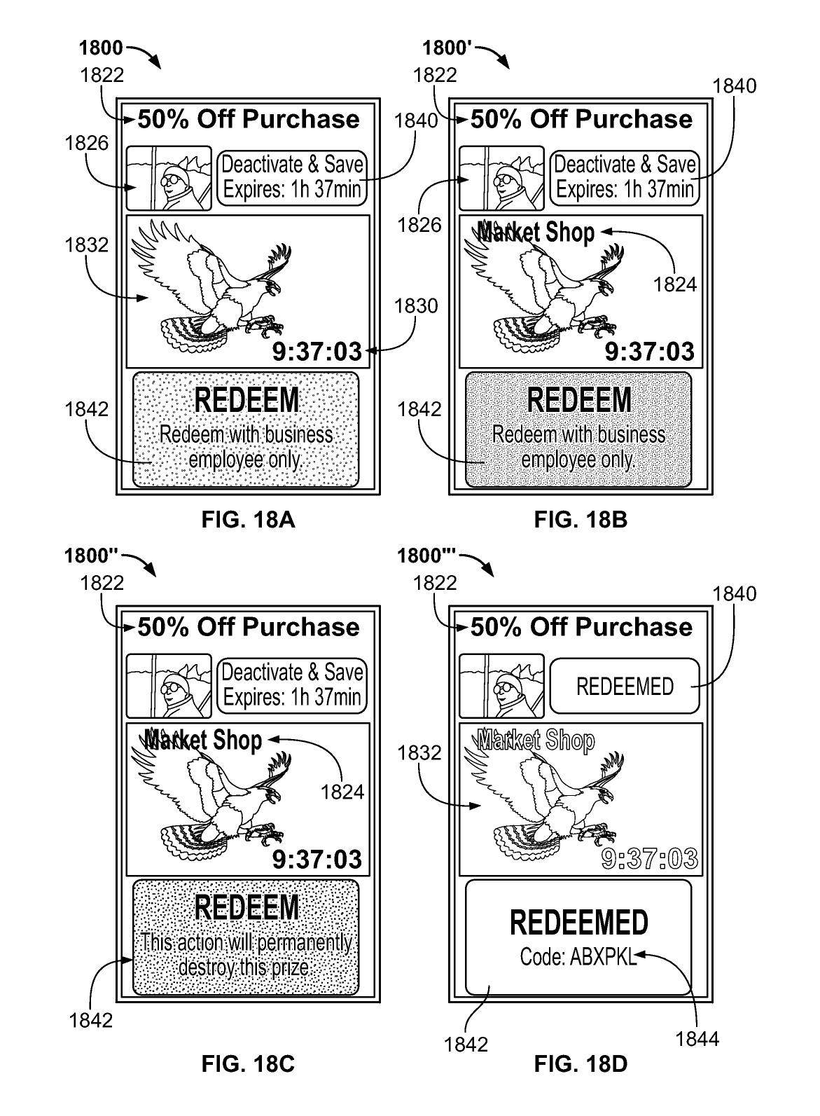

In regard to enhanced reward redemption, a first mechanism for redemption is a Reward Screen 1800, shown by way of example in FIG. 18a in unactivated form. Once activated, as indicated in FIG. 18b, 1802, the merchant name “Market Shop” appears and, as an example, the “REDEEM” section 1820 has changed to a selected color, and a time stamp 1822 is shown. The Reward Screen 1800-1806 of FIG. 18 has some anti-fraud aspects, but, alone, is a less secure redemption means, and thus, alone, may be suitable for small rewards only, such as a T-shirt, a free side dish and the like. Thus, the user in the presence of a merchant employee or by the action of the merchant employee, may activate the “REDEEM” section 1830, before, e.g., as shown in FIG. 18d, this changes to another selected color, such that the Reward Screen 1806 now indicates, as shown in FIG. 18d that the enhanced reward has been redeemed and a unique identifier code 1832 for the particular enhanced reward 1810 in FIGS. 18b and c, received from the RDS server 304, is displayed identifying the particular enhanced reward 1810 that was redeemed. Thus reward redemption can provide for relatively secure and essentially instantaneous redemption, with the basic verification needed done on the user's phone 350. Advanced verification using online tools, displayed bar codes and the like with novel anti-abuse and anti-forgery methods are applicable. Emailed prizes, gift codes or credits, printable tickets, mailed prizes, including gift cards and other physical objects are also possible. Examples of advantages of the disclosed subject matter above and beyond such available programs as Facebook Deals, Foursquare, SCVNGR and the like may be seen in an ability to create increased awareness by customers and merchants, etc. through seeing friends and associates playing Bozuko, e.g., in association with a check-in at a merchant location, win big enhanced prizes and the like through Facebook posts and check-in applications. Hearing and reading about others playing for and winning big enhanced rewards many times the value of normal loyalty program rewards, such as check-in rewards, leads to even further participation by customers, tantalized by the possibility of winning a big prize now, and the thrill of playing a game to win or lose (i.e., at least simulated gambling).

This comes at a lower costs to the merchant. A 1:11 chance of winning costs businesses less than giving out 10% off coupons or other tokens to every participant. Even a 1:10 chance of winning costs the merchant less, assuming not all of the ten would redeem the normal unenhanced check-in reward coupon, and at worst costs the same. Bozuko increases the opportunities for involvement of branded manufactures of goods, umbrella organizations, such as the mall, the stadium, arena, the airport, etc. and combining with other merchant customer loyalty programs already in existence. Enhanced reward winners tell their friends and acquaintances directly or through a social network or the like, what they've won through Bozuko. This activity and other publicity increases customer engagement by and with the merchant, and can provide promotional programs where the participants may not be at the merchant site for a particular campaign, but are encouraged to come to the location either to be able to participate or to redeem an enhanced reward and thus, perhaps spend even more money at the merchant location, or neighboring merchant locations.

Users gain “status” at a merchant(s) with frequent visits and online engagement and advance in the level of advertising value to the merchant, and thus, e.g., games available, value of the enhanced rewards, chance of getting the enhanced reward and the like as the user's value to the merchant as a recipient of and channel for the distribution of targeted, focused, real time, geographically specific and/or “friend” endorsed advertisements. Bozuko “Status” rewards customer loyalty and online engagement, as an example through the rewards distribution a campaign matrix as discussed above. Users may move up/down in status levels at each merchant, and for each campaign of the merchant or group of campaigns of a merchant, e.g., Basic I, Basic II, “Regular”, “Gold,” etc., which may also be denominated in more catchy terms, such as “Tourist,” “Regular,” “Preferred,” “High Roller,” etc. based on history of play, customer profile, advertising value to the merchant, enhanced advertising value due to the size and content of the users social network or the like account(s), which levels may have requirements set by or selectable by the merchant through the core application. The merchant defines the level of enhanced reward, e.g., Regular, Gold, Platinum, Premium, which may be denominated by positions in the campaign matrix 200, and the like, e.g., based on either or both of the advertising value perceived by the merchant in giving out higher and higher value enhanced rewards and the advertising value of the participants given access to these higher valued enhanced rewards, and, thus, advancing down and/or to the right in selected campaigns in the campaign matrix 200. As will be apparent to those in the art Bozuko is a centralized web-based application with modular components providing great versatility. Merchants sign up for and configure their account and campaigns on-line. Mobile-Phone applications get functional data from web applications. Social network, such as Facebook, interaction is from web application to public application programming interfaces (“APIs”)

Merchant accounts are set up easily and in varying degrees more or less automatically, with a web-based graphical user interface for the merchant to interact with the core application. New games and functions can be rapidly added to the user's mobile application or be made accessible as hosted on the RDS. Support of various mobile user platforms is fast and manageable. Support for additional social networks is readily available and easy to deploy. APIs allow for developers to integrate Bozuko into or supplemental to third-party applications. Sophisticated anti-forgery, anti-fraud and anti-abuse mechanisms are provided and an architecture is provided that is integratable with other component functionalities, such as a social network, a consumer purchase plan system, and related issuer, transaction handler and merchant customer loyalty programs and also including communication and network connection providers, all cooperating with the other functionalities for such as electronic advertising programs, including targeted, focused, real time and the like advertising and promotional programs, and all in a system that is scalable to support a global demand. Bozuko can result in somewhat massive advertising value for brands and businesses, e.g., considering 100 users checking in on average can be equal to 13,000+ friends seeing the activity, which can double or quadruple or more for broadcasting similar activity, game selection, game play, game result, and other activity such as targeted advertisements to the on average 130 friends. The notifications and advertising is “endorsed,” friend-to-friend. The resulting customer engagement of a check-in, e.g., on Facebook, provides users and friends a channel to the merchant and added on “Likes” provide more endorsement and enable the customer to gain status to encourage even more future engagement of customer. Customer loyalty is promoted and rewarded for more frequent visits. The customers will enjoy playing Bozuko! These and other aspects of Bozuko attract and retain more users through enhanced rewards, social benefits, and fun. Winning enhanced rewards now and meaningful status over time is a positive effect on customer loyalty and loyalty to the Bozuko-based customer loyalty rewards program random enhanced reward distribution system. Initially being integrated with an existing social network means the user has no new community to join. The games are simple, understandable, easy to engage in simulated play and fun. Bozuko is a tool for merchants to attract and retain more customers and thus for Bozuko to get more merchants to establish loyalty program random enhanced reward distribution system campaigns with Bozuko. Enhanced rewards won encourage other customers to check-in and/or otherwise play and/or otherwise participate in Bozuko presented opportunities to be selected to receive a randomly distributed enhanced loyalty program reward. Bozuko allows brands, and not just the merchant, to easily take part in enhanced reward random distribution system campaigns. This can be offered at a relatively to exceedingly small cost, e.g., with a payment model for the merchant to the RDS operator of a monthly fee of $25.00 and $0.02 cents per check-in, per notification of the user playing Bozuko, per participation event, per notification of the play result, i.e., $0.08 cents total, for 100 user check-ins/day=3000 check-ins/month, would result in $145.00 in monthly charge for some 1.56 million views by users friends, again assuming 130 friends on average for an average Facebook user.

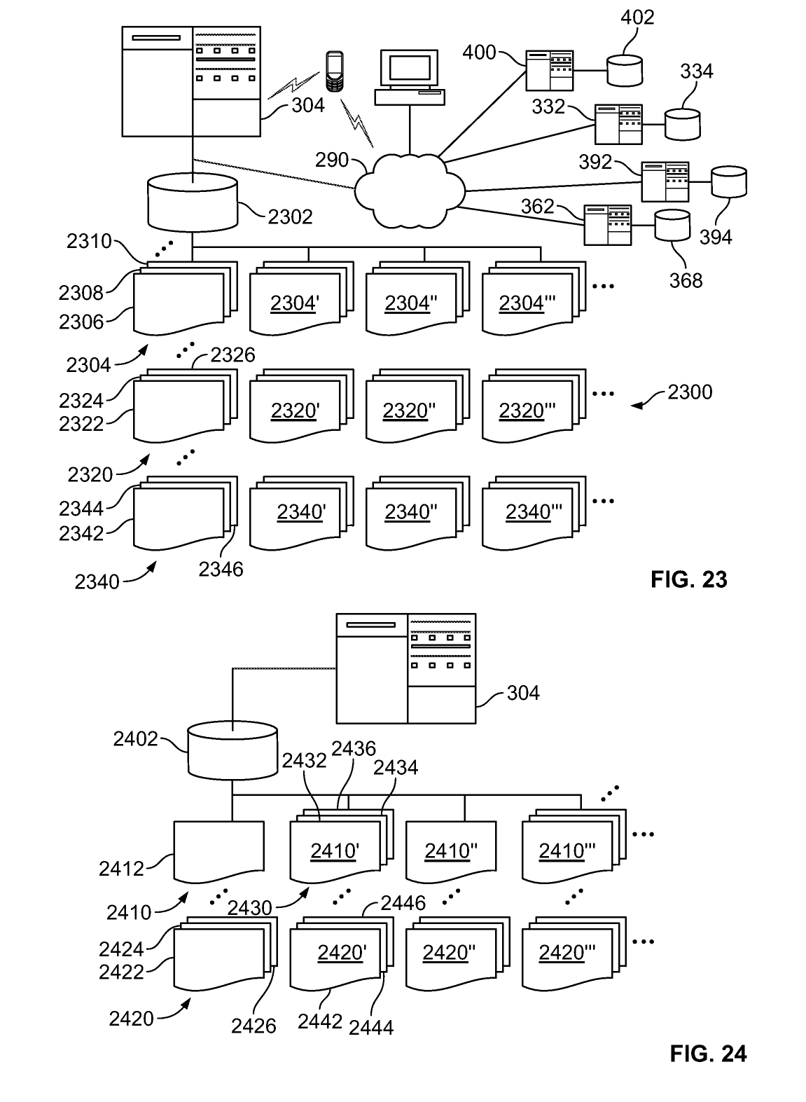

Turning now to FIG. 23, there is shown by way of an example, a participant database system 2300, useful in cooperation with the customer loyalty reward program random enhanced reward distribution system and method according to aspects of the disclosed subject matter. The participant database system 2300 may be implemented within a participant database 2302 connected to the customer loyalty reward program random enhanced reward distribution system server(s) 304, which is in turn connected, directly or through the Internet 290, or otherwise to social network server(s) 400 and associated social network database(s) 402, a communications connection provider server 332 and associated database(s) 334, a merchant server(s) 392 and associated merchant database(s) 394, and consumer payment system transaction handler server(s) 268 and associated database(s) 368. Each of the servers 304, 332, 362, 392 and 400 may also be in communication with each other through the Internet 290 or otherwise and share or exchange data from the associated databases.

Within the participant database 2302 may be, as an example a plurality of participant folders 2304, 2304’, 2304″, 2304′″, etc. Each of the folders 2304, 2304′, 2304″, 2304,′″ . . . may include participant information files, such as a participant ID file 2306, which may include, e.g., a unique identifier for the participant, such as a globally unique ID number (“GUID”), which may be associated with the user by the customer loyalty reward program random enhanced reward distribution system server(s) 304 or shared with one or more of the other servers 332, 362, 392 and 400, and may include other components, e.g., a user ID photograph, e.g., obtained from the social network server 400. The folders 2304, 2304′, 2304″, 2304,′″ . . . may also include an other user ID information file 2308, including such as a URL, a cellular telephone number, or other communications connection, an email address(es), etc. The folders 2304, 2304′, 2304″, 2304,′″ . . . may also include an other user information file 2310 containing, e.g., a user profile submitted by the user. It will be understood that the information about the user/participant may be downloaded from any one or more of the other server(s) 332, 362, 392 and 400 and associated databases 334, 368, 394 and 402, etc. and permanently stored in the information folders 2304, 2304′, 2304”, 2304,′″ and the like for each participant/user or may be accessed as needed, e.g., to establish one or more of the criteria related to a particular level or levels of advertising value to a given merchant for a given merchant customer loyalty reward program random enhanced reward distribution campaign.

The participant database 2302 for each participant identified in the participant's folders 2304, 2304′, 2304″, 2304,′″ . . . may have a social network folder 2320, 2320′, 2320″, 2320′″, etc. The social network folder 2320, 2320′, 2320″, 2320′″, etc. may include a plurality of files 2322, 2324, 2326, etc., each identifying a social network, such as FaceBook®, of which the participant/user is a member, and contain such contact information for the particular social network as to provide for at least communication between the customer loyalty reward program random enhanced reward distribution system server(s) 304 and the social network server, e.g., 400.

Each of the files 2322, 2324, 2326, etc. may be associated with a contacts/connections folder 2340, 2340′, 2340″, 2340′″, etc. Each contacts/connections folder 2340, 2340′, 2340″, 2340′″, etc. may include a plurality of contacts/connections files, e.g., broken down into a contacts file 2342, e.g., listing contacts obtained for the user participant by the customer loyalty reward program random enhanced reward distribution system server(s) 304 from the social network server 400, or one or more of the other servers 332, 362, 392, 400, etc., a “friends” file, e.g., listing “friends” (or other equivalent designations) of the user participant, within, e.g., FaceBook, e.g., having some defined direct contact with the user/participant in the respective social network according to the practices and processes of the particular social network, and a “friends of friends” file 2348, for contacts connected to the user participant in the respective social network by being, e.g., a “friend” of a “friend,” i./e., someone directly connected to someone also directly connected to the user/participant within the social network. Further files (not shown) may identify “friends of friends of friends” and so forth.

It will be understood that, as noted above, the information in these respective files may be downloaded and permanently stored in the database 2302, from one or more of the other servers 332, 362, 392, 400, and/or the associated databases 334, 368, 394 and 402 or accessed and/or stored temporarily for such actions as determining participant/user advertising value to a campaign, e.g., based on social network and other connections and also performing the notification activities noted in the present application.

Another database associated with the customer loyalty reward program random enhanced reward distribution system server(s) 304 can include, by way of example, a merchant campaign database 2402 illustrated in one example in FIG. 24. At a first level the database may identify merchant locations in a merchants folder 2410, 24120′, 2410″, 2410′″, etc., each of which may include a merchant location file 2412, identifying that merchant 2410 has only one location participating in a customer loyalty reward program random enhanced reward distribution campaign, and 2432, 2434 and 2436, indicating that merchant 2410′ has three locations participating in a customer loyalty reward program random enhanced reward distribution campaign, and so forth. For each location file 2412, 2432, 2434 and 2436, etc, e.g., for the respective merchant folders 2410, 24120′, 2410″, 2410′″, etc. a campaign folder 2420, 2420′, 2420″, 2420′″, etc. identifies each respective customer loyalty reward program random enhanced reward distribution campaign, e.g., 2422, 2424, 2426, 2442, 2444, 2446, etc., as discussed above.

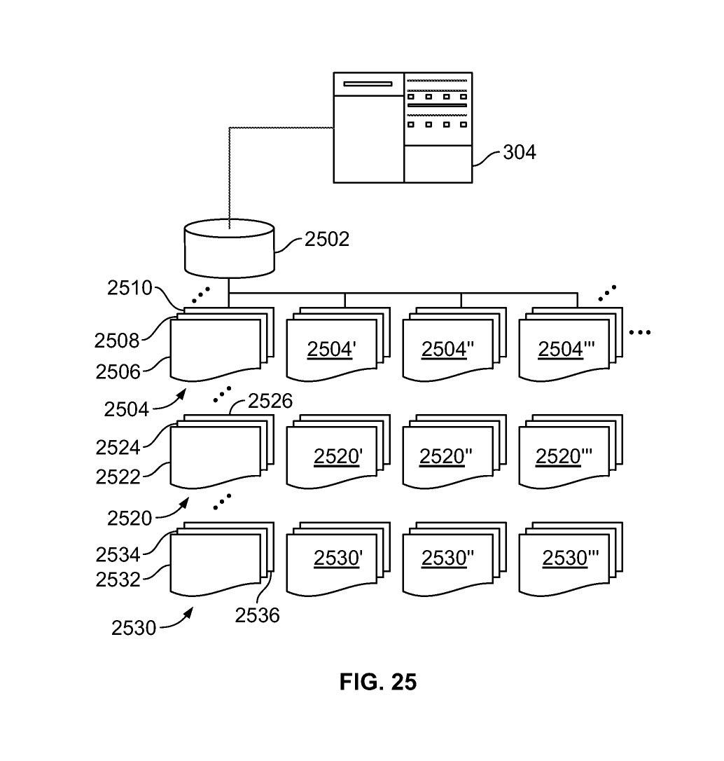

Turning to FIG. 25 there is shown by way of example a campaign database 2502. Within the campaign database 2502 may be stored a plurality of merchant campaign folders 2504, 2504′, 2504″, 2504′″, etc. Each merchant campaign folder 2504, 2504′, 2504″, 2504′″, etc. can have a plurality of campaign files 2505, 2508, 2510, etc. each identifying a particular campaign for a particular merchant, i.e., each file 2505, 2508, 2510, etc. can be identified with a unique ID for the particular campaign, which also is tied to the particular merchant. Each campaign file 2505, 2508, 2510, etc. can, e.g., identify a particular results array, which, as discussed above, may be used to determine the random distribution of rewards. For each file 2505, 2508, 2510, etc. there can be associated a rewards folder, 2520, 2520′, 2520″, 2520′″, etc.

Each rewards folder 2520, 2520′, 2520″, 2520′″, etc. can have a plurality of rewards files, such as, 2522, 2524, 2526, etc., each identifying a particular reward associated with the particular campaign, 2505, 2508, 2510, etc. The reward files can each, e.g., identify a position in a results array Each rewards folder 2520, 2520′, 2520″, 2520′″, etc. can have a plurality of reward status files, 2532, 2534, 2536, etc. Each reward status file 2532, 2534, 2536, etc. may indicate a status a reward, e.g., pending, selected for award, being redeemed, redeemed, etc. The information in these latter files may be used, e.g., to initiate the carrying out of, e.g., notification functions discussed above, such as when a user participant elects to play a game to get a distribution of a pending enhanced reward, the reward is selected for distribution to a participant/user, the reward is being redeemed or has been redeemed, etc.

As used in this application, and as is well understood by those skilled in the art, the term “computing device,” such as may form a part of a system or be utilized to perform method steps as part of a method, according to aspects of an embodiment of the disclosed subject matter for providing a customer loyalty reward program random enhanced reward distribution system and method, by way of example, may comprise a computer processor or other processor unit capable of obtaining and executing instructions, such as application and operating system software instructions. The processor may be any form of hardware device for executing software instructions which may be stored in and obtained from a storage medium, such as cache memory, main memory, local disc storage and remote disc or other storage and may reside in different ones of such types of storage media at the same time or at different times.

The processor may be any custom made or commercially available processor, a central processing unit (CPU), an auxiliary processor among several processors associated with the processing unit, a semiconductor based microprocessor (in the form of a microchip or chip set), a macroprocessor, a microcontroller, an array of processors, a networked group or array of computing devices or generally any device(s) for executing software instructions. The processor may comprise a controller, microcontroller, or a hard wired, including firmware, device, or any combination thereof, or any other processor capable of performing logic driven operations, according to partly or fully programmable instructions.

As is also well understood by those skilled in the art, software operating on the processor may include one or more separate programs, each of which comprises an ordered listing of executable instructions for implementing logical functions. Software may be in the form of application software and operating system software which is stored in a tangible medium, such as any of the storage media (memories) noted above. The operating system essentially controls the execution of other computer programs by the computing device. Software may be written and compiled as (a) an object oriented programming language, which has classes of data and methods, or (b) a procedure programming language, which has routines, subroutines, and/or functions, such as C, C++, Pascal, Basic, Fortran, Cobol, Perl, Java, and Ada or standard Internet languages, such as XML or HTML.

In the context of this disclosure, a tangible computer readable medium may be any electronic, magnetic, optical, or other physical device or means that can contain or store a computer program instructions for use by or in connection with a computing device related system or method. The tangible computer readable medium can be, for example, but not limited to, an electronic, magnetic, optical, electromagnetic, infrared, or semiconductor system, apparatus, device, or other non-transitory propagation medium, including, by way of example an electrical connection (electronic) having one or more wires, a portable computer diskette (magnetic), a random access memory (RAM) (electronic), a read-only memory (ROM) (electronic), an erasable programmable read-only memory (EPROM) (electronic), an electronically erasable programmable read only memory (“EEPROM”)(electronic), a Flash memory (electronic), an optical fiber memory (optical), a portable compact disc read-only memory (CDROM) (optical), a tape (magnetic), a large disc storage medium (magnetic), etc., all as is known and understood by those skilled in the art.

For the purposes of this disclosure a module is a software, hardware, or firmware (or combinations thereof) system, process or functionality, or component thereof, that performs or facilitates the processes, features, and/or functions described herein of a module (with or without human interaction or augmentation). A module can include sub-modules. Software components of a module may be stored on a computer readable medium as noted above. Modules may be integral to one or more servers, or be loaded and executed by one or more servers. One or more modules may be grouped into an engine or an application.

The presently disclosed subject matter is described below with reference to block diagrams and/or operational illustrations of methods and devices to perform methods according to aspects of an embodiment of the disclosed subject matter (collectively “block diagram”). It is understood that each block of the block diagram can be implemented by means of analog or digital hardware and computer program instructions, such as on a computing device or a communication device. In some alternate implementations, the functions/acts noted in the blocks or steps can occur out of the order noted in the block diagrams. For example, two blocks shown in succession can in fact be executed substantially concurrently, on the same processor or on different processors in parallel, or the blocks can sometimes be executed in the reverse order, depending upon the functionality/acts involved.

For the purposes of this disclosure the term “server” should be understood to refer to a service point which provides processing, database, and communication facilities, again, as is well known and understood by those in the art. By way of example, and not limitation, the term “server” can refer to a single physical processor with associated communications and data storage and database facilities, or it can refer to a networked or clustered or arrayed complex of processors including massively parallel and pipelined processors, and associated network, communication and storage devices, as well as operating software and one or more database systems and applications software which support the services provided by the server, all of which may be also referred to as a computing device or a communication device, as may be consistent with the context of the system and method being described or claimed.

Depending upon the context in which described or claimed a communication device or communication network, as will be understood by those in the art, may be more than one physical device operating to carry out the communication function described, such as any one of a number of computing devices such as PCs, MACs, PDAs, etc. interfaced to communications networks, such as the Internet, or any number of hand held portable communications devices, such as a cellular phone, Blackberry, I-Pod, Droid, or groups, arrays or networks thereof, interconnected directly or indirectly, such as through a LAN and/or a gateway, to communications network stations and facilities, such as through cellular phone base stations, the Internet, the public switched network, etc. Any or all of such components of a communication device/system acting in series or in parallel, or combinations thereof, with associated transmitting and receiving equipment, coding and decoding equipment, encryption and decryption equipment, modulating and demodulating equipment, computing devices, data bases and the like equipment, necessary for, and capable of, carrying out the disclosed or claimed communication referenced in the present application.

As used in this application, merchant shall be taken to mean any person or entity that provides goods or services or a combination of goods and services, to a customer, in person or over a network communication system or other business entity which owns or manages a location where merchants congregate, such as a mall, airport, stadium, arena, park, beach or other recreational area and the like. A participating merchant is a merchant that agrees to provide loyalty program enhanced rewards determined according to aspects of the disclosed subject matter to a user/participant in return for the user/participant participating in a customer loyalty program, such as a check-in advertising program, e.g., through or in cooperation with a social network system, such as over the Internet, including as examples “FaceBook,” “Foursquare,” “Twitter” and the like social networking and communication platforms and systems, such as blogs, chat rooms, iTunes, etc., including any on-line social network platform or system that currently exists or comes into being in the future, some of which have been noted herein.

As used herein, the terms “Internet” and “World Wide Web” can be substantially interchangeably and can be used to refer to a network of computer networks which operates world-wide using a common set of communications protocols, electronically linking a substantial portion of the uniform resource locators stored by InterNIC. As used herein, the term “website” can be described as follows. The entire collection of web pages, documents and/or other information (e.g., images, sound, and video files, . . . ) that are made available through the Internet and generally appear to be a single web destination. As used herein, the term “search engine” can be used to refer to a component of the Internet employed to help users find websites based upon key words. Search engines can maintain data stores of websites and/or use software programs such as “spiders”, “robots” and/or “crawlers” to collect information for the data stores, which is then indexed. A search engine can be used synonymously with Internet “directories”, but can also be distinguished by the ordering/indexing of the websites. It is to be appreciated that search engines can be comprised of both hardware and software.

The foregoing presents a simplified summary of the disclosed and claimed subject matter in order to provide a basic understanding of some aspects of the disclosed and claimed subject matter. This summary is not an extensive overview of the disclosed or claimed subject matter. It is intended to neither identify key or critical elements of the disclosed and claimed subject matter nor fully or solely delineate the scope of the claimed subject matter. Its sole purpose is to present some concepts of the disclosed and claimed subject matter in a simplified form for the purpose of explaining aspects of the content of and operation of the disclosed and claimed subject matter.

These aspects are indicative, however, of but a few of the various ways in which the principles of the disclosed and claimed subject matter may be put into practice, employed and utilized and the disclosed and claimed subject matter is intended to include all such aspects and their equivalents. Other advantages and features of the disclosed and claimed subject matter will be apparent to those skilled in the art from the above detailed description of the disclosed and claimed subject matter considered as well in conjunction with the drawings. It will be evident to those skilled in the art that the disclosed and claimed subject matter may be practiced without the use of specific details referenced above. Well-known structures and devices have been described and/or are shown in block diagram form in order to facilitate describing aspects of the disclosed and claimed subject matter. As noted, the above description and drawings are illustrative and are not to be construed as limiting. Numerous specific details are described to provide a thorough understanding. However, in certain instances, well known or conventional details are not described in order to avoid obscuring the description.

Reference in this specification to “one embodiment” or “an embodiment” means that a particular feature, structure, or characteristic described in connection with the embodiment is included in at least one embodiment of the disclosed subject matter. The phrase “in one embodiment” appearing in various places in the specification is not necessarily all referring to the same embodiment, nor are separate or alternative embodiments mutually exclusive of other embodiments. Moreover, various features are described which may be exhibited by some embodiments and not by others. Similarly, various aspects are described which may be aspects for one or more embodiments but not all other embodiments.

1. A customer loyalty rewards program random enhanced reward distribution system comprising:
a random enhanced reward distribution system server receiving an indication that a user is a qualified participant because the user is one of a recipient of customer loyalty rewards program currency and qualified to be a recipient of customer loyalty rewards program currency;
the random enhanced reward distribution server configured to provide the user with a representation of a game, via a communication network;
the random enhanced reward distribution system server configured to receive, via the communication network, from the user, an indication that the user participates using the representation of the game;
the random enhanced reward distribution server determining whether the user is an enhanced reward recipient.

2. The system of claim 1 further comprising:
the reward distribution server configured to determine whether the user is an enhanced reward recipient by selecting a position in a results array predetermined to contain the indication of whether the user is an enhanced reward recipient.

3. The system of claim 2 further comprising:
the random enhanced reward distribution system server configured to receive, via a communication network, from a merchant, a definition of a customer loyalty reward program random enhanced reward distribution campaign;
the random enhanced reward distribution system server configured to conduct the random enhanced reward distribution system campaign defined by the merchant.

4. The system of claim 3 wherein the definition by the merchant includes a cost to the merchant criteria:
the random enhanced reward distribution system server configured to create the results array for the campaign wherein a number of participants receiving the random enhanced reward within a given number of participation events satisfies the cost to the merchant criteria.

5. The system of claim 1 further comprising:
the random enhanced reward distribution system server configured to:
provide a reward distribution system campaign definition interface whereby a merchant having a consumer loyalty program can define the random enhanced reward distribution campaign; and
administer the random enhanced reward distribution system defined by the merchant for the merchant.

6. The system of claim 5 wherein the merchant defines at least one aspect of the enhanced reward distribution campaign.

7. The system of claim 1 wherein the customer loyalty reward program is a location check-in reward program and the customer loyalty program currency is a check-in reward.

8. The system of claim 7 wherein the enhanced customer loyalty program reward is higher than the check-in reward.

9. The system of claim 1 wherein the customer loyalty reward program is a behavior inducement check-in.

10. The system of claim 9 wherein the enhanced customer loyalty program reward is higher than an amount of customer loyalty currency normally received to induce the behavior.

11. The system of claim 2 further comprising:
the enhanced reward distribution system server configured to provide to the merchant a loyalty program enhanced reward campaign matrix populated by a selection of predetermined campaigns of increasing cost to the merchant progressing down and/or to the right in the matrix; and
the enhanced reward distribution system server configured to receive from the merchant a selection of at least one enhanced reward campaign from the enhanced reward campaign matrix for the reward distribution system server to conduct.

12. A method comprising:
receiving, via a random enhanced reward distribution system server, an indication that a participant is a qualified participant because the participant is one of a recipient of customer loyalty rewards program currency and qualified to be a recipient of customer loyalty rewards program currency;
providing, via the random enhanced reward distribution server, the participant with a representation of a game;
receiving, via the random enhanced reward distribution system server, from the participant, an indication that the participant engages in a participation event using the representation of the game;
determining, via the random enhanced reward distribution server, whether the participation event results in the participant receiving an enhanced reward.

13. A method comprising:
providing, via a random enhanced reward distribution server, a representation of a game of chance to a participating user with an opportunity to engage in a participation event;
determining, via the random enhanced reward distribution server, the outcome of the participation event;
providing, via the random enhanced reward distribution server, to the participant a representation of an outcome of the participant event in the form of an outcome of the game of chance resulting in one of a distribution of an enhanced reward and a non-distribution of an enhanced reward;
notifying, at least in part via the random enhanced reward distribution server, at least one of a plurality of social network connections of the participant of the outcome of the participation event.

14. A method comprising:
receiving, via a random enhanced reward distribution system server, an indication that a user is a qualified participant because the participant is a participant in a non-location check-in event wherein the participant engages in an activity in which a merchant desires the participant to engage;
providing, via the random enhanced reward distribution server, the participant with a representation of a game;
receiving, via the random enhanced reward distribution system server, from the participant, an indication that the participant engages in a participation event using the representation of the game;
determining, via the random enhanced reward distribution server, whether the participation event results in the participant receiving an enhanced reward.

15. A method comprising:
providing to a merchant having a customer loyalty program random enhanced reward distribution system account, via a random enhanced reward distribution system server, an enhanced reward distribution campaign matrix, each campaign in the campaign matrix defining a game of chance provided to a participant in the campaign, having an increasing level of merchant reward value commitment along a first coordinate axis of the matrix and an increased level of participant advertising value to the merchant along a second coordinate axis of the matrix; and
administering at least one customer loyalty program enhanced reward distribution campaign, via the random enhanced reward distribution system server, selected from the matrix by the merchant, on behalf of the merchant.

16. A method comprising:
receiving, via a random enhanced reward distribution system server, an indication that a participant is a qualified participant as defined by a merchant loyalty program enhanced reward distribution campaign, the campaign defining a temporal duration D for the campaign, and defining a respective defined award play time tₐ at which each respective enhanced reward will be awarded to a participant during the duration D of the campaign;
providing, via the random enhanced reward distribution server, the participant with a representation of a game;
receiving, via the random enhanced reward distribution system server, from the participant, an indication that the participant engages in a participation event using the representation of the game at a participation play time tₚ;
determining, via the random enhanced reward distribution server, whether the participation event results in the participant being awarded an enhanced reward based on one of the participation play time tₚ corresponding to a defined award play time tₐ and the existence of at least one unawarded enhanced reward for which a previous defined award play time tₐ, within the duration D of the campaign, which defined award play time tₐ passed without a participation event at a participation play time tₚ corresponding to the defined award play time tₐ that passed.
